(19) United States
(12) Patent Application Publication
(10) Pub. No.: US 2008/0058979 A1
(43) Pub. Date: Mar. 6, 2008

(54) STRIP THREADING METHOD AND STRIP THREADING DEVICE

(76) Inventor: Takeaki NAKANO, Noda-shi (JP)

Correspondence Address: BIRCH STEWART KOLASCH & BIRCH, PO BOX 747, FALLS CHURCH, VA, 22040-0747, US

(21) Appl. No.: 11/847,019

(22) Filed: Aug. 29, 2007

(30) Foreign Application Priority Data
Aug. 30, 2006 (JP) 2006-233269

(51) Int. Cl. G03B 1/58; G01B 5/10; G06F 19/00

(52) U.S. Cl. 700/122; 226/92; 702/157

(57) ABSTRACT

Web is in the form of two web rolls, each of which is obtained by winding the web in a roll. The web of a selected one of the two web rolls is configured to be threaded into a transport route of a printing press by causing a holder to hold a forward edge portion of the web, and by thus moving the holder by drive of a motor while causing the web to be rotated and unwound by a corresponding one of motors. Before threading the web into the transport route, the diameter of the selected one of the web rolls is measured in order to calculate the transport speed of the web or the speed at which the web is unwound from the corresponding one of the web rolls so that the speed at which the web is threaded should be adequate.

### BACKGROUND OF THE INVENTION

1. Field of the Invention

The present invention relates to a strip threading method of, and a strip threading device for, threading a strip into a strip transport route in an apparatus.

2. Description of the Related Art

In a case of an apparatus for processing a strip of paper, film, cloth, nonwoven fabric and the like, the strip needs to be threaded into the apparatus before processing the strip. For example, in a case of a web rotary printing press, new web needs to be unwound and threaded into a web transport route of the printing press before printing the web. For this reason, the web is designed to be threaded into the transport route, for example, from a feeder to a folder in the following manner. First of all, guide rails are laid along the web transport route in the printing press. A holder which holds the forward edge of the web is guided by, and moved along, the rails. Web threading devices of this kind are automated. (Refer to Japanese Publication of Unexamined Utility Model Application Hei. 1-103647)

In the case of such an automated web threading device, the holder for threading web with the forward edge of the web held is transported slightly slower than the web is transported. An operator constantly monitors what conditions the web is in while the web is being threaded. When the web becomes too slackened, the operator manually adjusts the web in order that the holder can be transported slightly faster than the web is transported.

In the case of such an automated web threading device, the operator has to adjust the web when the web becomes too slackened through constantly monitoring the web as described above, no matter how the web threading devices may be automated. This imposes heavy burden on the operator. Furthermore, when the operator negligently or inadvertently fails to monitor the web, it is likely that the web becomes too slackened or too tensioned so that the web is ripped off. Once the web is ripped off, new web has to be threaded into the transport route again. This makes the work inefficient. With this problem taken into consideration, consideration is given to controlling the speed at which the web is threaded in order to maintain the web speed adequately. To this end, however, it is necessary that the diameter of the web roll be grasped.

### SUMMARY OF THE INVENTION

A first aspect of the present invention for solving the foregoing problem provides a strip threading method of threading a strip into a strip transport route in an apparatus by causing a towing member to hold the forward edge of the strip wound in a roll, and by thus moving the towing member while causing the strip wound in the roll to be rotated and unwound by drive means. The strip threading method includes a step of measuring the diameter of the strip wound in the roll before threading the strip into the transport route.

A second aspect of the present invention for solving the foregoing problem provides a strip threading method of threading a strip into a strip transport route in an apparatus by causing a towing member to hold the forward edge of the strip wound in a roll, and by thus moving the towing member while causing the strip wound in the roll to be rotated and unwound by drive means. The strip threading method includes a step of measuring the diameter of the strip wound in the roll while threading the strip into the transport route.

A third aspect of the present invention for solving the foregoing problem provides the strip threading method according to the first or second aspect of the present invention, further includes a step of controlling the rotational speed of the drive means for rotating the strip wound in the roll depending on the measured diameter of the strip wound in the roll.

A fourth aspect of the present invention for solving the foregoing problem provides the strip threading method according to the first or second aspect of the present invention, further includes a step of controlling the speed at which the towing member is moved depending on the measured diameter of the strip wound in the roll.

A 5th aspect of the present invention for solving the foregoing problem provides a strip threading device for threading a strip into a strip transport route in an apparatus by causing a towing member to hold the forward edge of the strip wound in a roll, and by thus moving the towing member while causing the strip wound in the roll to be rotated and unwound by drive means. The strip threading device includes diameter measuring means for measuring the diameter of the strip wound in the roll before threading the strip into the transport route.

A 6th aspect of the present invention for solving the foregoing problem provides a strip threading device for threading a strip into a strip transport route in an apparatus by causing a towing member to hold the forward edge of the strip wound in a roll, and by thus moving the towing member while causing the strip wound in the roll to be rotated and unwound by drive means, and thereby threading the strip into a strip transport route in an apparatus. The strip threading device includes diameter measuring means for measuring the diameter of the strip wound in the roll while threading the strip into the transport route.

A 7th aspect of the present invention for solving the foregoing problem provides the strip threading device according to the 5th or 6th aspect of the present invention, further includes rotation controlling means for controlling the speed at which the drive means rotates depending on the measured diameter of the strip wound in the roll.

An 8th aspect of the present invention for solving the foregoing problem provides the strip threading device according to the 5th or 6th aspect of the present invention, further includes speed controlling means for controlling the speed at which the towing member is moved depending on the measured diameter of the strip wound in the roll.

The strip threading method according to the first aspect of the present invention and the strip threading device according to the 5th aspect of the present invention make it possible to discharge an operator from work for measuring the diameter, to prevent the web roll from being fed out at a wrong speed which would result from an input of the diameter of a web roll as a result of a mismeasurement or from a wrong input of the diameter of the web roll, and to accordingly prevent the strip from being ripped off or damaged. This is because the diameter of the strip wound in the roll is designed to be measured before threading the strip into the transport route.

The strip threading method according to the second aspect of the present invention and the strip threading device according to the 6th aspect of the present invention make it possible to discharge an operator from work for measuring the diameter, to prevent the web roll from being fed out at a wrong speed which would result from an input of the diameter of a web roll as a result of a mismeasurement or from a wrong input of the diameter of the web roll, and to accordingly prevent the strip from being ripped off or damaged. This is because the diameter of the strip wound in the roll is designed to be measured while threading the strip in the transport route.

The strip threading method according to the third aspect of the present invention and the strip threading device according to the 7th aspect of the present invention make it possible to prevent an excessive force from being applied to the unwound strip, and to accordingly prevent the strip from being ripped off or damaged. This is because the speed at which the drive means rotates is designed to be controlled on the basis of the measured diameter of the strip.

The strip threading method according to the fourth aspect of the present invention and the strip threading device according to the 8th aspect of the present invention make it possible to prevent an excessive force from being applied to the unwound strip, and to accordingly prevent the strip from being ripped off or damaged. This is because the speed at which the towing member is moved is designed to be controlled on the basis of the measured diameter of the strip.

### BRIEF DESCRIPTION OF THE DRAWINGS

The present invention will become more fully understood from the detailed description given hereinbelow and the accompanying drawings which are given by way of illustrations only, and thus are not limitation of the present invention, and wherein:

FIG. 1 is a schematic diagram of a printing press as an example to which the present invention is applied;

FIG. 2 is a schematic diagram of a web threading device in the printing press;

FIG. 3 is a schematic diagram of an automated web threading device according to an embodiment;

FIG. 4 is a schematic diagram of a remaining web length measuring gauge;

FIG. 5A is a block diagram of a part of a control system of an automated web threading device;

FIG. 5B is a block diagram of another part of the control system of the automated web threading device;

FIG. 6 is a block diagram of a control system of the remaining web length measuring gauge;

FIG. 7A is a flowchart showing an operational sequence which is followed by an automated web threading device and a method thereof according to a first embodiment;

FIG. 7B is a flowchart showing an operational sequence coming after the operational sequence shown in FIG. 7A, which is followed by the automated web threading device and the method thereof according to the first embodiment;

FIG. 7C is a flowchart showing an operational sequence coming after the operational sequence shown in FIG. 7B, which is followed by the automated web threading device and the method thereof according to the first embodiment;

FIG. 7D is a flowchart showing an operational sequence coming after A shown in each of FIGS. 7A and 7C, which is followed by the automated web threading device and the method thereof according to the first embodiment;

FIG. 7E is a flowchart showing an operational sequence coming after the operational sequence shown in FIG. 7D, which is followed by the automated web threading device and the method thereof according to the first embodiment;

FIG. 7F is a flowchart showing an operational sequence coming after the operational sequence shown in FIG. 7E, which is followed by the automated web threading device and the method thereof according to the first embodiment;

FIG. 7G is a flowchart showing an operational sequence coming after the operational sequence shown in FIG. 7F, which is followed by the automated web threading device and the method thereof according to the first embodiment;

FIG. 7H is a flowchart showing an operational sequence coming after the operational sequence shown in FIG. 7F, which is followed by the automated web threading device and the method thereof according to the first embodiment;

FIG. 8A is a flowchart showing an operational sequence which is followed by a remaining web length measuring gauge according to the first embodiment;

FIG. 8B is a flowchart showing an operational sequence coming after the operational sequence shown in FIG. 8A, which is followed by the remaining web length measuring gauge according to the first embodiment;

FIG. 9 is a flowchart showing a part of an operational sequence which is followed by an automated web threading device and a method thereof according to a second embodiment; and

FIG. 10 is a flowchart showing another part of the operational sequence which is followed by the automated web threading device and the method thereof according to the second embodiment.

### DETAILED DESCRIPTION OF THE INVENTION

### Embodiment 1

Detailed descriptions will be provided below for embodiments of a strip threading method and a device using the method according to the present invention on the basis of the drawings. An embodiment which will be described below is that which is applied to a web rotary printing press for printing web as a strip. This embodiment relates to the web rotary printing press which automatically threads web before the printing press starts its operation. Web is designed to be threaded by use of mechanisms respectively of, and information on, a web splicing unit and a remaining web length measuring gauge which have been beforehand provided to the printing press.

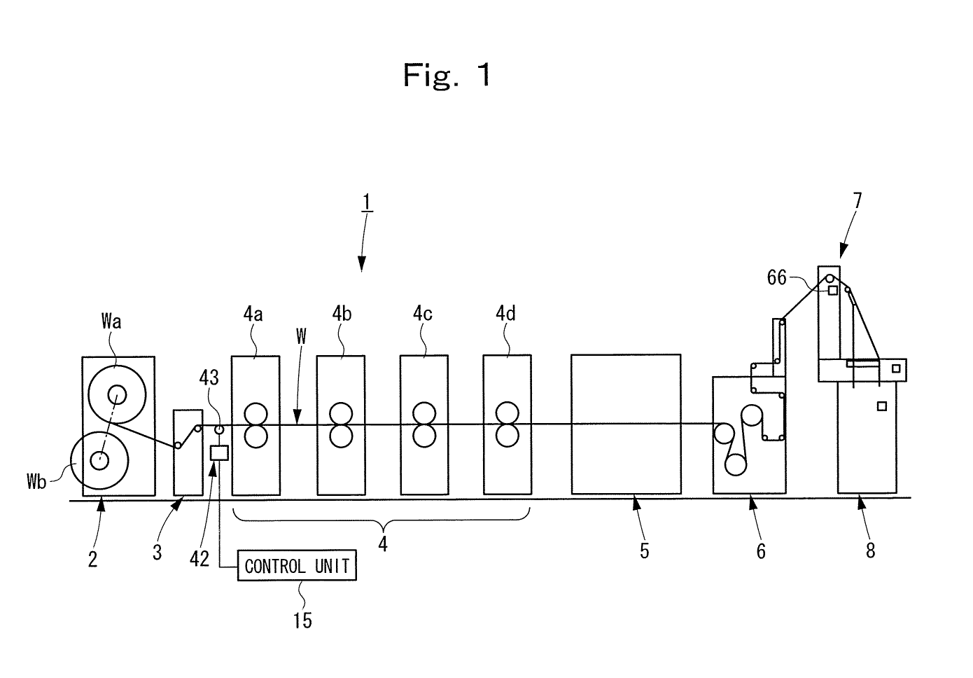

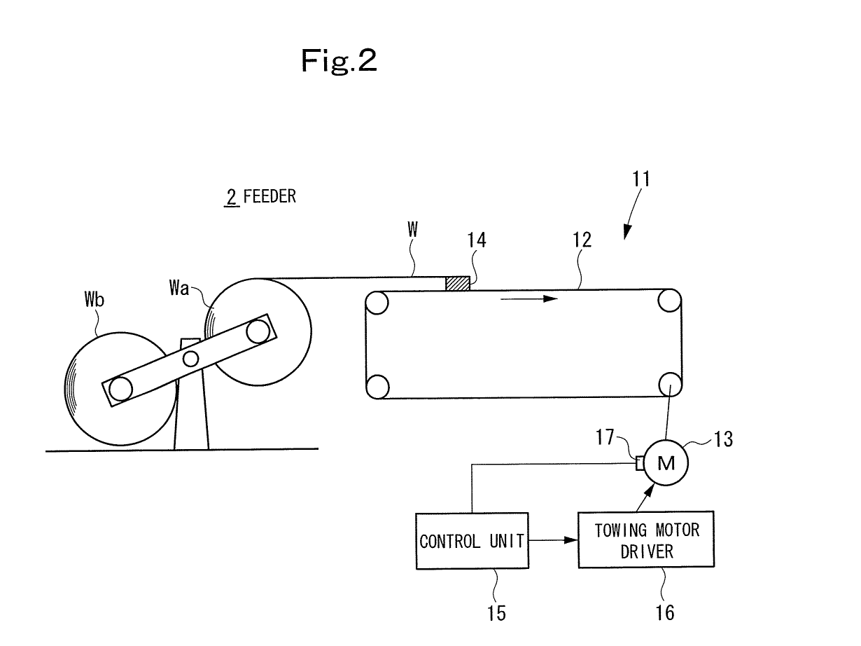

FIG. 1 shows a schematic configuration of the web rotary printing press. FIG. 2 shows a schematic configuration of the automated web threading device. On the basis of these drawings, first of all, descriptions will be provided for the schematic configuration of the web rotary printing press and the schematic configuration of the automated web threading device.

As shown in FIG. 1, a web rotary printing press 1 is configured of a feeder 2, an infeeder 3, a printer 4, a dryer 5, a cooler 6 and a folder 8. Web rolls (rolls of wound web) Wa and Wb are held in the feeder 2. Each of the web rolls Wa and Wb is web W as a strip wound in a roll. The infeeder 3 is arranged at the side of an exit of the feeder 2, and guides the fed web. The printer 4 is arranged after the infeeder 3, and includes four printing units 4a to 4d. The dryer 5 is arranged after the printer 4. The cooler 6 is arranged after the dryer 5. The folder 8 is arranged after the cooler 6 with a web path section 7 interposed in-between.

The web W is continuously supplied from the feeder 2 and the infeeder 3. While passing through the first to the fourth printing units 4a to 4b in the printer 4, the web W is printed in various manners. Subsequently, the resultant web W is dried while passing through the dryer 5. Thereafter, the resultant web W is cooled while passing through the cooler 6. Afterward, the resultant web W is fed to the folder 8 via the web path section 7. When the resultant web W comes in the folder 8, the web W is cut and folded in a predetermined shape.

In a case where new web W is intended to be printed by the web rotary printing press 1 of this kind, the web has to be threaded from the feeder 2 through the folder 8. A transport route is that through which the web W passes from the feeder 2 to the folder 8. An automatic sheet threading device (automated web threading device) for feeding the web W to the transport route is arranged along the transport route.

The automated web threading device 11 as shown in FIG. 2 includes a chain 12 and a towing motor 13. The chain 12 is arranged in the transport route in an endless manner. The towing motor 13 drives the chain 12 separately from the apparatus (including various rolls). A holder 14 as a towing member is attached to the chain 12. The forward edge of the web W which is going to be threaded is held by this holder 14. The towing motor 13 is controlled through a towing motor driver 16 on the basis of instructions from a control unit (automated web thread controlling unit) 15 in the automated web threading device 11. In addition, the rotation of the towing motor 13 is detected by use of a rotary encoder 17.

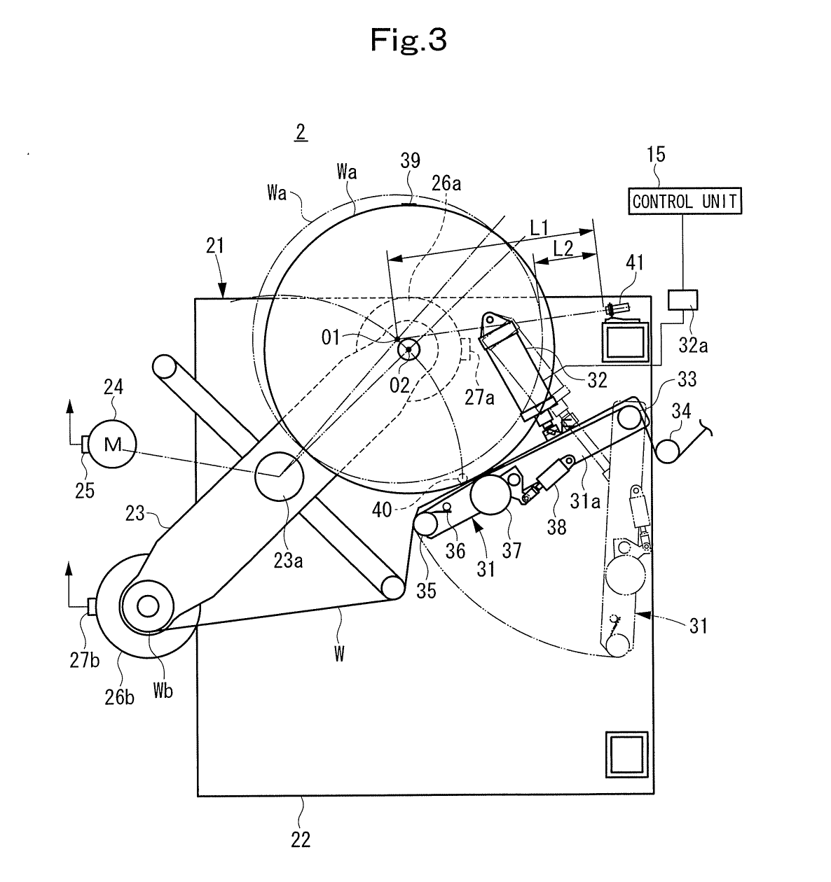

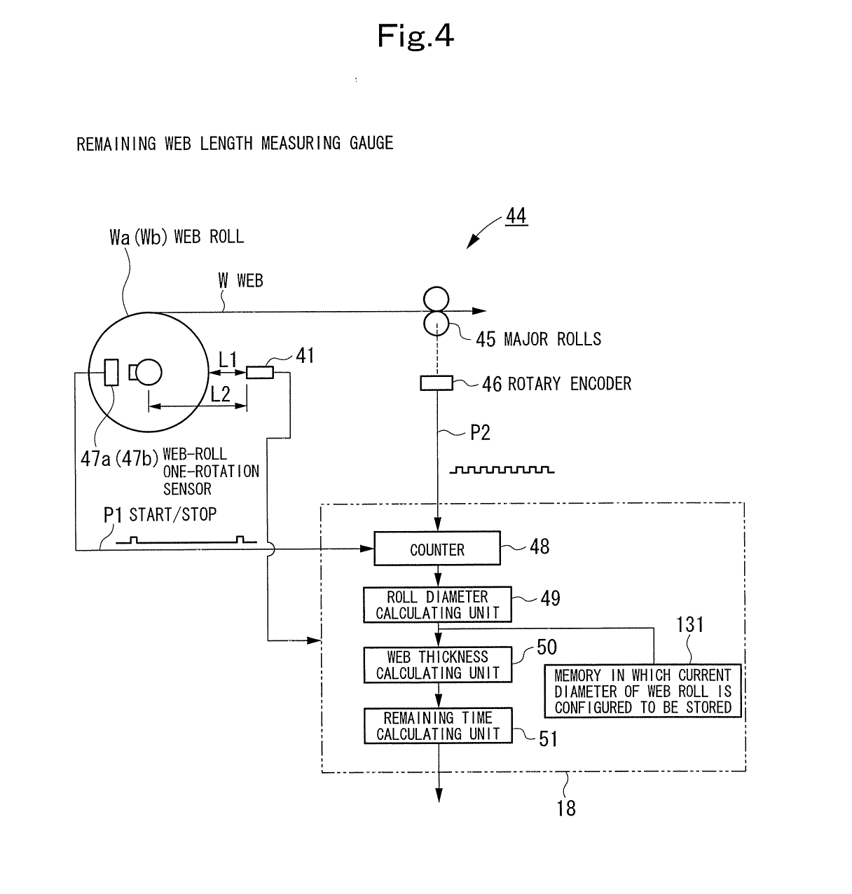

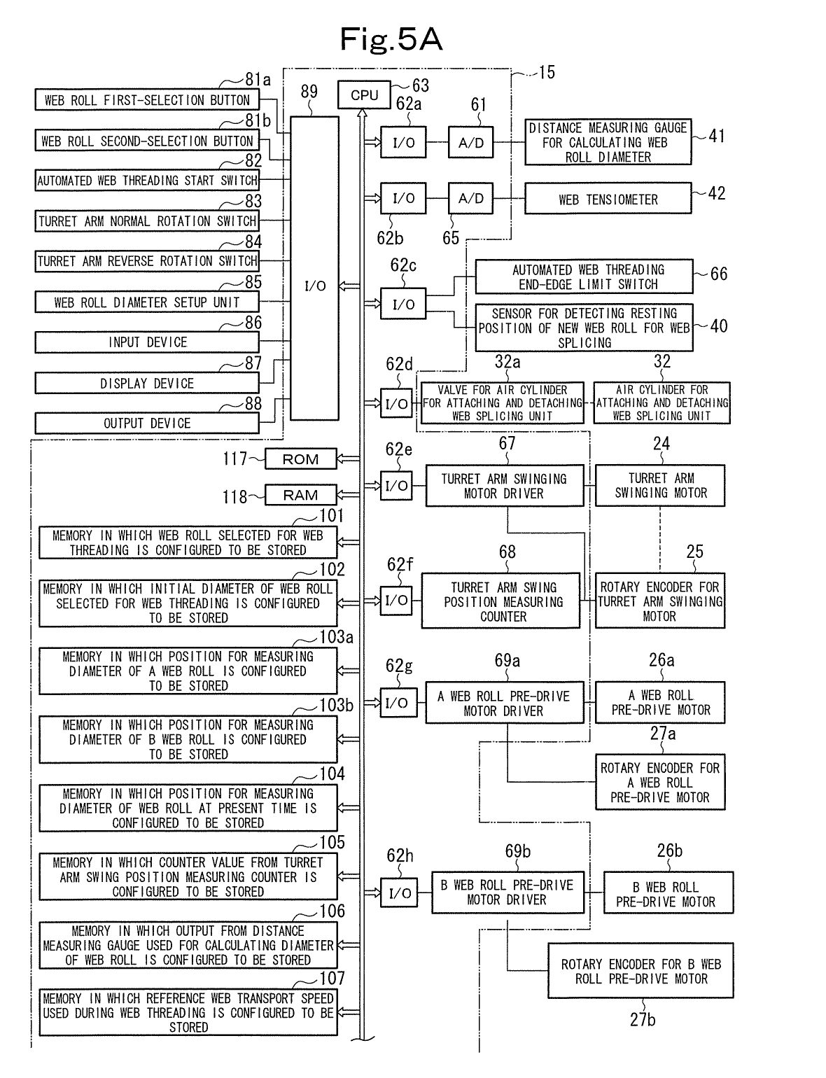

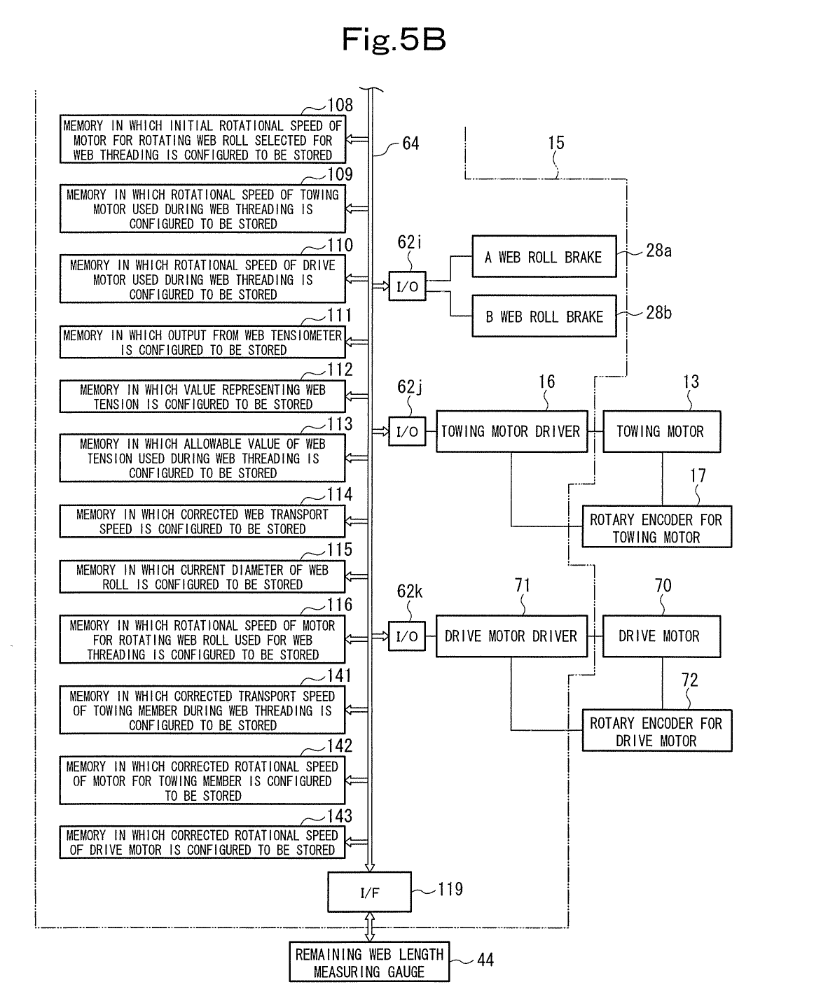

FIG. 3 shows a schematic configuration of the feeder which is a part of the automated web threading device 11 according to the present embodiment. Furthermore, FIG. 4 shows a block diagram of a remaining web length measuring gauge for measuring the remaining web length of each of the web rolls Wa and Wb which are in the process of unwound. FIGS. 5A and 5B are block diagrams each showing the control unit 15 in the automated web threading device 11 according to the present embodiment.

As shown in FIG. 3, a web feeding unit 21 is a chief part of the feeder 2. A turret arm 23 is supported by a center shaft 23a of its own at a location afterward of a unit main body 22 of the web feeding unit 21 in a way that the turret arm 23 is capable of swinging about the center shaft 23a. Two ends of the turret arm 23 are provided respectively with reels (referred to as an “A shaft” and a “B shaft”). The web rolls are attached respectively to the reels. In FIG. 3, Wa denotes the web roll attached to the reel around the A shaft, and Wb denotes the web roll attached to the reel around the B shaft. In addition, the web roll in the process of being unwound is termed as an old web roll, and the web roll which has been attached newly is termed as a new web roll. In FIG. 3, the web roll Wa attached to the reel around the A shaft is a new web roll, and the web roll Wb attached to the reel around the B shaft is an old web roll.

When web W of an old web roll Wb is unwound to come close to an end, web W of a new web roll Wa is spliced to the web W of the old web roll Wb. Thereby, the web W is continuously fed to the printer 4. The web of the new web roll Wa is spliced to the web of the old web roll Wb automatically. FIG. 3 shows a condition in which the web of the old web roll Wb is currently unwound to come close to an end, the turret arm 23 is swung, and the new web roll Wa is moved to a resting position for web splicing. In FIG. 3, the web roll Wa in the resting position for web splicing is drawn in a solid line. In FIG. 3, reference numeral 02 denotes the center of the web roll Wa in the resting position for web splicing.

A turret arm swinging motor 24 is linked to the center shaft 23a of the turret arm 23. The turret arm 23 is swung by drive of the turret arm swinging motor 24. An angle at which the turret arm 23 is swung is measured by causing a rotary encoder 25 to detect an angle at which the rotational shaft of the turret arm swinging motor 24 has been rotated.

The two ends of the turret arm 23 are provided respectively with web roll pre-drive motors 26a and 26b which function as the web roll rotating motor as well. The rotational shafts of the respective web roll pre-drive motors 26a and 26b are connected to the reels on a one-to-one basis. In other words, the web rolls Wa and Wb are driven and rotated respectively by the web roll pre-drive motors 26a and 26b. The web roll pre-drive motors 26a and 26b are those each for beforehand accelerating the surface speed of the new web roll Wa which has been moved to the resting position for web splicing until the surface speed of the new web roll Wa becomes equal to the running speed of the web W which is currently being unwound when the webs are going to be spliced together. It should be noted that, in the case of the present embodiment, the web roll pre-drive motors 26a and 26b are also used as sources of rotational drive respectively of the web rolls Wa and Wb while the web is threaded automatically. The rotational speeds of the web roll pre-drive motors 26a and 26b are detected respectively by rotary encoders 27a and 27b for the web roll pre-drive motors which are provided to the web roll pre-drive motors 26a and 26b. The web roll pre-drive motors 26a and 26b respectively include web roll brakes 28a and 28b (not illustrated in FIG. 3, but illustrated in FIG. 5 only). The web roll brakes 28a and 28b are those which respectively arrest the rotational shaft of the web roll pre-drive motors 26a and 26b so that the web rolls Wa and Wb in their resting positions should not rotate.

A web splicing unit 31 is arranged in an upper position in the unit main body 22 of the web feeding unit 21, and the upper position is at the side of the exit of the web feeding unit 21. The web splicing unit 31 is that for splicing new web to old web. The web splicing unit 31 is swingably arranged there in a way that the web splicing unit 31 comes close to, and goes away from, the web roll Wb in the resting position for web splicing. The web splicing unit 31 includes a frame 31a which is swingably supported by the unit main body 22 at the side of the exit of the unit main body 22. A movable end of an air cylinder 32 for attaching and detaching the web splicing unit is linked to this frame 31a. The rear end portion of the air cylinder 32 for attaching and detaching the web splicing unit is supported by the unit main body 22. Depending on an operation of the air cylinder 32 for attaching and detaching the web splicing unit, the web splicing unit 31 is moved back and forth between a position where the web splicing unit 31 is detached from the web roll Wa in the resting position for web splicing and a position where the web splicing unit 31 is attached to the web roll Wa there. The position where the web splicing unit 31 is detached from the web roll Wa there is illustrated with a long dashed double-short dashed line. The position where the web splicing unit 31 is attached to the web roll Wa there is illustrated with a solid line. In FIG. 3, reference numeral 32a denotes a valve for actuating the air cylinder 32 for attaching and detaching the web splicing unit. The opening and the closing of the valve is controlled by an instruction from the control unit 15.

While the web splicing unit 31 has been moved and stays at the position where the web splicing unit 31 is attached to the web roll Wa in the resting position for web splicing, the web W unwound out of the old web roll Wb is caused to pass through an interstice between the new web roll Wa and the web splicing unit 31. Thereafter, the unwound web W is fed out to the printer 4 via multiple rolls 33 and 34 which are arranged at the side of the exit of the unit main body 22. The shaft about which the roll 33 is arranged is the same as the shaft about which the frame 31a rotates.

A guide roll 35 for guiding the web W is arranged in a free end of the frame 31a. A cutter 36 for cutting a part of the web W which is hooked around the guide roll 35 is provided to a portion near the guide roll 35 in the frame 31a. A cutter air cylinder, which is not illustrated, causes the cutter 36 to go forward to, and come backward from the web W. The frame 31a is provided with a press-contact roller 37. An air cylinder 38 for the press-contact roller brings the press-contact roller 37 into contact with, and separates the press-contact roller 37 from, the surface of the web roll Wa in the resting position for web splicing. It should be noted that, although not illustrated, the web splicing unit 31 is provided with a tape position detecting sensor for detecting the double-side adhesive tape 39 adhered to the forward edge of the web roll Wa.

The unit main body 22 is provided with a sensor for detecting a resting position of a new web roll for web splicing (hereinafter referred to as a “resting position sensor”) 40. This resting position sensor 40 is provided to the unit main body 22 in a way that the resting position sensor 40 cuts across the route through which the turret arm 23 transports the new web roll Wa to the resting position. By detecting a portion corresponding to the outside diameter of the new web roll Wa in the resting position for web splicing, the resting position detector 40 detects that the new web roll Wa is currently in the resting position, or that the web roll Wa has just come to the resting position. A transmission photoelectric sensor or the like is used as this resting position sensor 40. In a case where a photoelectric sensor is used as the resting position sensor 40, the new web roll Wa blocks a beam of light traveling from the photo-emitter to the photo-detector. Thereby, the photoelectric sensor 40 detects that the new web roll Wa has come to the resting position.

The unit main body 22 is provided with a distance measuring gauge for calculating a web roll diameter (hereinafter referred to as a “distance measuring gauge”) 41 which is configured to find the diameter of the new web roll Wa. The distance measuring gauge 41 is arranged in a position which is opposite to the peripheral surface of the new web roll Wa when the new web roll Wa remains in a home position for the measurement. The distance measuring gauge 41 measures the distance between the distance detecting gauge 41 and the peripheral surface of the new web roll Wa by use of an ultrasonic wave and a beam of light (laser beam). From a result of the measurement, the distance measuring gauge 41 finds the diameter d1 of the web roll. In other words, the diameter d1 of the web roll is found by

d1=2(L1−L2)

where L2 denotes the distance between the distance measuring gauge 41 and the surface of the web roll Wa, and L1 denotes the already-known distance between the distance measuring gauge 41 and the center O1 of the web roll Wa situated in the home position for the measurement.

As shown in FIG. 1, a web tensiometer 42 is arranged at the side of the entrance of the printer 4. The web tensiometer 42 is that for detecting the tension in the web W by bringing a detection roll 43 into contact with the web W. It should be noted that the location where the web tensiometer 42 should be arranged is not limited to the position at the side of the entrance of the printer 4, and may be any position along the transport route.

Descriptions will be provided next for a remaining web length measuring gauge 44 as shown in FIG. 4.

As shown in FIG. 4, measure rolls 45 are arranged in a way that the measure rolls are in contact with the web W unwound out. By causing the measure rolls 45 to be in contact with the web W, the measure rolls 45 are rotated at a surface speed equal to the speed at which the web W is running. Rotation of the measure roll 45 is detected by a rotary encoder 46. Thus, the rotary encoder 46 outputs a pulse (pulse P2) each time the measure rolls 45 rotate at a unit rotational angle. On the other hand, a web-roll one-rotation sensor 47a (47b) is arranged for the purpose of detecting a rotation of the web roll Wa (Wb) situated in the position for unwinding a web. The web-roll one-rotation sensor 47a (47b) is provided to the reel to which the web roll Wa (Wb) is attached. Each time the reel makes one rotation, the web-roll one-rotation sensor 47a (47b) detects the rotation, and thus outputs one pulse (pulse P1). Pulses P2 from the rotary encoder 46 and pulses P1 from the web-roll one rotation sensor 47a (47b) are inputted to a counter 48 in a control unit (control unit in the remaining web length measuring gauge) 18. On the basis of the number of counted pulses, a roll diameter calculating unit 49 calculates the diameter of the web roll Wa (Wb).

The counter 48 resumes counting the number of pulses P2 from the rotary encoder 46 each time the counter 48 receives a pulse P1 from the web-roll one-rotation sensor 47a (47b). The counter 48 stops counting the number of pulses P2 from the rotary encoder 46 each time the counter 48 receives a next pulse P1 from the web-roll one-rotation sensor 47a (47b). Thereby, the counter 48 counts a length N of the web which has been fed for each rotation of the web roll Wa (Wb). The diameter which the web roll Wa (Wb) takes each time the web roll Wa (Wb) makes one rotation can be calculated by dividing the counted value N by the circle ratio π. It should be noted that, for the purpose of eliminating the influence of tension, eccentricity, warp, winding condition and the like of the web roll Wa (Wb) on the change in the diameter of the web roll Wa (Wb), the roll diameter calculating unit 49 calculates the diameter of the web roll Wa (Wb) by averaging values N which are counted while the web roll Wa (Wb) makes multiple rotations (for example, 8 rotations) except for a maximum counted value and a minimum counted values.

In addition, the remaining web length measuring gauge is provided with a web thickness calculating unit 50 and a remaining time calculating unit 51 as essential mechanisms of the remaining web length measuring gauge, although neither the web thickness calculating unit 50 nor the remaining time calculating unit 51 is needed for web threading. The web thickness calculating unit 50 calculates a web thickness from the diameter of the web roll Wa (Wb) which is measured at the immediately previous time and the diameter of the web roll Wa (Wb) which is measured at the present time. From the remaining web length and the speed at which the web W is running, the remaining time calculating unit 51 calculates the length of time remaining before the diameter of the web roll Wa (Wb) becomes equal to a predetermined diameter.

The automated web threading device 11 includes not only the constituent members as shown in FIGS. 1 to 4 but also other components, other sensors, and the like. Descriptions will be provided for these components, sensors and the like on the basis of FIG. 5 which is a block diagram of the control unit 15. The control unit 15 includes rotation controlling means according to the 7th aspect of the present invention and speed controlling means according the 8th aspect of the present invention. It should be noted that an entire block diagram of the control unit 15 is covered by FIGS. 5A and 5B.

The distance measuring gauge 41 is connected to a bus 64 with an A/D converter 61 and an input-output device (I/O) 62a interposed in-between. The bus 64 is connected to a CPU 63. The web tensiometer 42 is similarly connected to the bus 64 with an A/D converter 65 and an input-output device 62b interposed in-between.

As shown in FIG. 1, an automated web threading end-edge limit switch 66 is arranged in an entrance portion of the folder 8. The automated web threading is completed when the web is threaded up to this automated web threading end-edge limit switch 66. At this time, the automated web threading end-edge limit switch 66 detects the web W. This automated web threading end-edge limit switch 66 and the resting position sensor 40 are connected to the bus 64 with an input-output device 62c interposed in-between. The input-output device 62c is shared by the automated web threading end-edge limit switch 66 and the resting position sensor 40.

The valve 32a for actuating the air cylinder 32 for attaching and detaching the web splicing unit is connected to the bus 64 with an input-output 62d interposed in-between.

A turret arm swinging motor driver 67 for outputting a drive instruction to the turret arm swinging motor 24 is connected to the bus 64 with an input-output device 62e interposed in-between. The rotary encoder 25 for detecting an angle at which the turret arm swinging motor 24 rotates is connected to a turret arm swing position measuring counter 68 for calculating a position of the turret arm 23 (an angle at which the turret arm 23 is swung) on the basis of a result of the detection by the rotary encoder 25. The turret arm swing position measuring counter 68 is connected to the bus 64 with an input-output device 62f interposed in-between. The rotary encoder 25 is designed to transmit a signal to the driver 67.

An A web roll pre-drive motor driver 69a is connected to the bus 64 with an input-output device 62g interposed in-between. The A web roll pre-drive motor driver 69a is that for giving a drive instruction to the A web roll pre-drive motor 26a for driving and rotating the web roll Wa attached to one end of the turret arm 23. The rotary encoder 27a for detecting rotation of the A web roll pre-drive motor 26a is designed to transmit a signal to the A web roll pre-drive motor driver 69a. Similarly, a B web roll pre-drive motor driver 69b is connected to the bus 64 with an input-output device 62h interposed in-between. The B web roll pre-drive motor driver 69b is that for giving a drive instruction to the B web roll pre-drive motor 26b for driving and rotating the web roll Wb attached to the other end of the turret arm 23. The rotary encoder 27b for detecting rotation of the B web roll pre-drive motor 26b is designed to transmit a signal to the B web roll pre-drive motor driver 69b. An A web roll brake 28a included in the A web roll pre-drive motor 26a is connected to the bus 64 with an input-output device 62i interposed in-between. A B web roll brake 28b included in the B web roll pre-drive motor 26b is connected to the bus 64 with the input-output device 62i interposed in-between.

The towing motor driver 16 gives a drive instruction to the towing motor 13 for driving the holder 14 which holds the forward edge of the web W. The towing motor driver 16 is connected to the bus 64 with an input-output device 62j interposed in-between. A signal from the rotary encoder 17 for detecting the rotation of the towing motor 13 is transmitted to the towing motor driver 16.

A drive motor driver 71 is connected to the bus 64 with an input-output device 62k interposed in-between. The drive motor driver 71 is that for giving a drive instruction to a drive motor 70 which is a drive source of the web rotary printing press 1 itself. A rotary encoder 72 detects rotation of the drive motor 70. Thus, a result of the detection is transmitted to the drive motor driver 71.

The control unit 15 includes the following components for an operator to operate the web rotary printing press 1.

The control unit 15 includes a web roll first-selection button 81a and a web roll second-selection button 81b for the operator to select a corresponding one out of the two web rolls. The web roll first-selection button 81a is used for selecting the web roll Wa attached to the A shaft of the turret arm 23. The web roll second-selection button 81b is used for selecting the web roll Wb attached to the B shaft of the turret arm 23. The control unit 15 includes an automated web threading start switch 82, a turret arm normal rotation button 83, a turret arm reverse rotation button 84, a web roll diameter setup unit 85, an input device 86, a display device 87, and an output device 88. The automated web threading start switch 82 is that for starting a job of threading the web W into the transport route when a printing is going to be started. The turret arm normal rotation button 83 is that for rotating the turret arm 23 in a normal direction. The turret arm reverse rotation button 84 is that for rotating the turret arm 23 in a reverse direction. The web roll diameter setup unit 85 is that for allowing the operator to manually input or setup a diameter of the web roll on the basis of an actual measurement or a record. Examples of the input device 86 include a keyboard. The display device 87 is a monitor. Examples of output device 88 include a printer. These components are connected to the bus 64 with an input-output device 89 interposed between the bus 64 and each of the components. The input-output device 89 is shared by these components.

In addition, the control unit 15 includes the following memories, and data needed for controlling the web threading is stored in a corresponding one of the memories. The memories included in the control unit 15 are: a memory 101 in which a web roll selected for the web threading is configured to be stored; a memory 102 in which an initial diameter of the web roll selected for the web threading is configured to be stored; a memory 103a in which a position for measuring the diameter of the A web roll is configured to be stored; a memory 103b in which a position for measuring the diameter of the B web roll is configured to be stored; a memory 104 in which a position for measuring the diameter of the web roll at the present time is configured to be stored; a memory 105 in which a counter value from the turret arm swing position measuring counter is configured to be stored; a memory 106 in which an output from the distance measuring gauge used for calculating the diameter of the web roll is configured to be stored; a memory 107 in which a reference web transport speed used during the web threading is configured to be stored; a memory 108 in which an initial rotational speed of the motor for rotating the web roll selected for the web threading is configured to be stored; a memory 109 in which a rotational speed of the towing motor used during the web threading is configured to be stored; a memory 110 in which a rotational speed of the drive motor used during the web threading is configured to be stored; a memory 111 in which an output from the web tensiometer is configured to be stored; a memory 112 in which a value representing a web tension is configured to be stored; a memory 113 in which an allowable value of a web tension used during the web threading is configured to be stored; a memory 114 in which a corrected web transport speed is configured to be stored; a memory 115 in which a current diameter of the web roll is configured to be stored; and a memory 116 in which a rotational speed of the motor for rotating the web roll selected for the web threading is configured to be stored. A web roll Wa or Wb selected for the web threading is stored in the memory 101. An initial diameter of the web roll selected for the web threading is stored in the memory 102. A position for measuring the diameter of the A web roll is stored in the memory 103a. A position for measuring the diameter of the B web roll is stored in the memory 103b. A position for measuring the diameter of the web roll at the present time is stored in the memory 104. A counter value from the turret arm swing position measuring counter 68 is stored in the memory 105. An output from the distance measuring gauge 41 is stored in the memory 106. A reference web transport speed used during the web threading is stored in the memory 107. An initial rotational speed of the motor (web roll pre-drive motor 26a or 26b) for rotating the web roll selected for the web threading is stored in the memory 108. A rotational speed of the towing motor 13 used during the web threading is stored in the memory 109. A rotational speed of the drive motor 70 used during the web threading is stored in the memory 110. An output from the web tensiometer 42 is stored in the memory 111. A value representing a web tension is stored in the memory 112. An allowable value of a web tension used during the web threading is stored in the memory 113. A corrected web transport speed is stored in the memory 114. A current diameter of the web roll is stored in the memory 115. A rotational speed of the motor (web roll pre-drive motor 26a or 26b) for rotating the web roll selected for the web threading is stored in the memory 116.

The control unit 15 includes a ROM 117 and a RAM 118 which are parts of its standing equipment in addition to the memories which have been described.

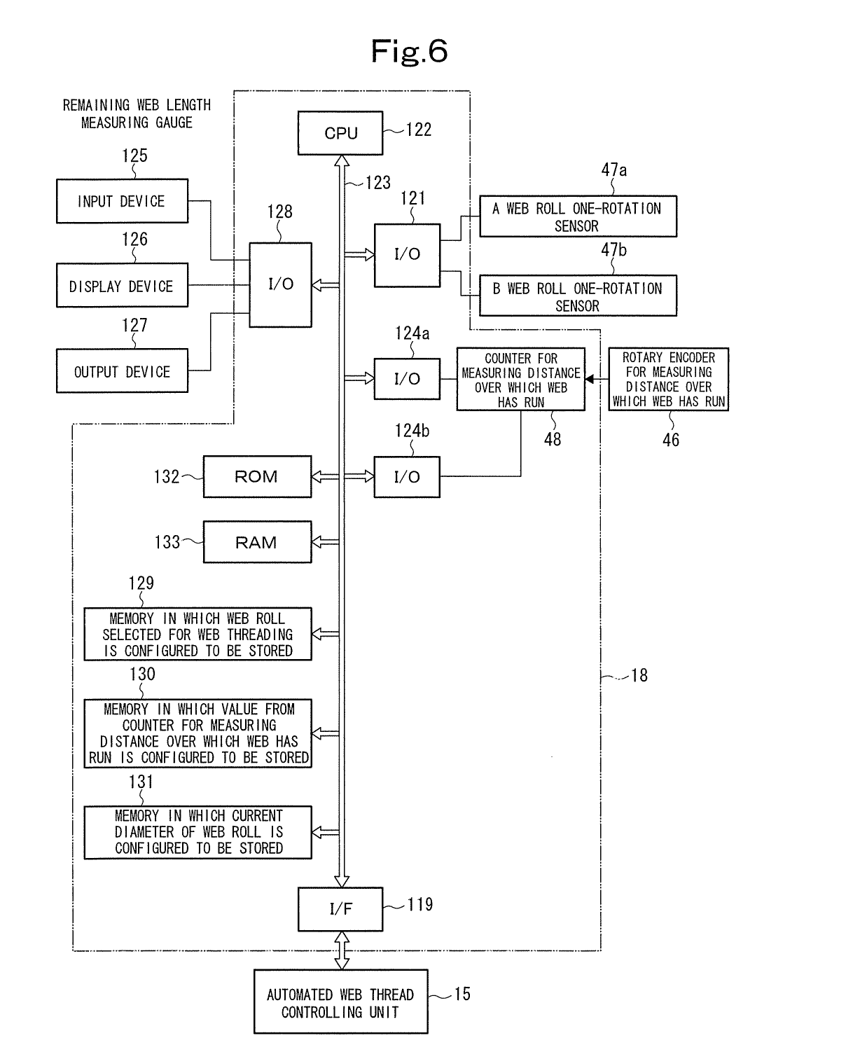

The remaining web length measuring gauge 44 is connected to the bus 64 of the control unit 15 with an interface (I/F) 119 interposed in-between. FIG. 6 shows a block configuration of the remaining web length measuring gauge 44.

The web-roll one-rotation sensor 47a is provided to the web roll Wa attached to the A shaft, and the web-roll one-rotation sensor 47b is provided to the web roll Wb attached to the B shaft. Both of the web-roll one-rotation sensors 47a and 47b are connected to a bus 123 of a CPU 122 with an input-output device (I/O) 121 interposed between the bus 123 and each of the web-roll one-rotation sensors 47a and 47b. The rotary encoder 46 for measuring a distance over which the web W has run by use of the measure rolls 45 to roll along with the web W is connected to the counter 48 for measuring an aggregate distance over which the web has run. The counter 48 for measuring an aggregate distance over which the web has run is connected to the bus 123 with input-output devices 124a and 124b interposed in-between for the purpose of transmitting a counted value to the CPU 122 and for the purpose of receiving a reset signal from the CPU 122.

The remaining web length measuring gauge 44 includes an input device 125 such as a keyboard, a display device 126 such as a monitor, and an output device 127 such as a printer. These devices are connected to the bus 123 with an input-output device 128 interposed between the bus 123 and the group of the devices. The input-output device 128 is shared among these devices.

The remaining web length measuring gauge 44 includes: a memory 129 in which a web roll selected for the web threading is configured to be stored; a memory 130 in which a value from the counter for measuring an aggregate distance over which the web has run is configured to be stored; and a memory 131 in which a current diameter of the web roll is configured to be stored. A web roll Wa or Wb (the A shaft or the B shaft) selected for the web threading is stored in the memory 129. A counter value from the counter 48 for measuring an aggregate distance over which the web has run is stored in the memory 130. A current diameter of the web roll is stored in the memory 131. The remaining web length measuring gauge 44 includes a ROM 132 and a RAM 133 which are parts of its standing equipment in addition to these memories. Data stored in the memory 101 in which a web roll selected for the web threading is configured to be stored in the automated web thread controlling unit 15 is transferred to, and is stored in, the memory 129 in which a web roll selected for the web threading is configured to be stored. In addition, data stored in the memory 131 in which the current diameter of the web roll is configured to be stored is transferred to, and is stored in, the memory 115 in which the current diameter of the web roll is configured to be stored in the automated web thread controlling unit 15.

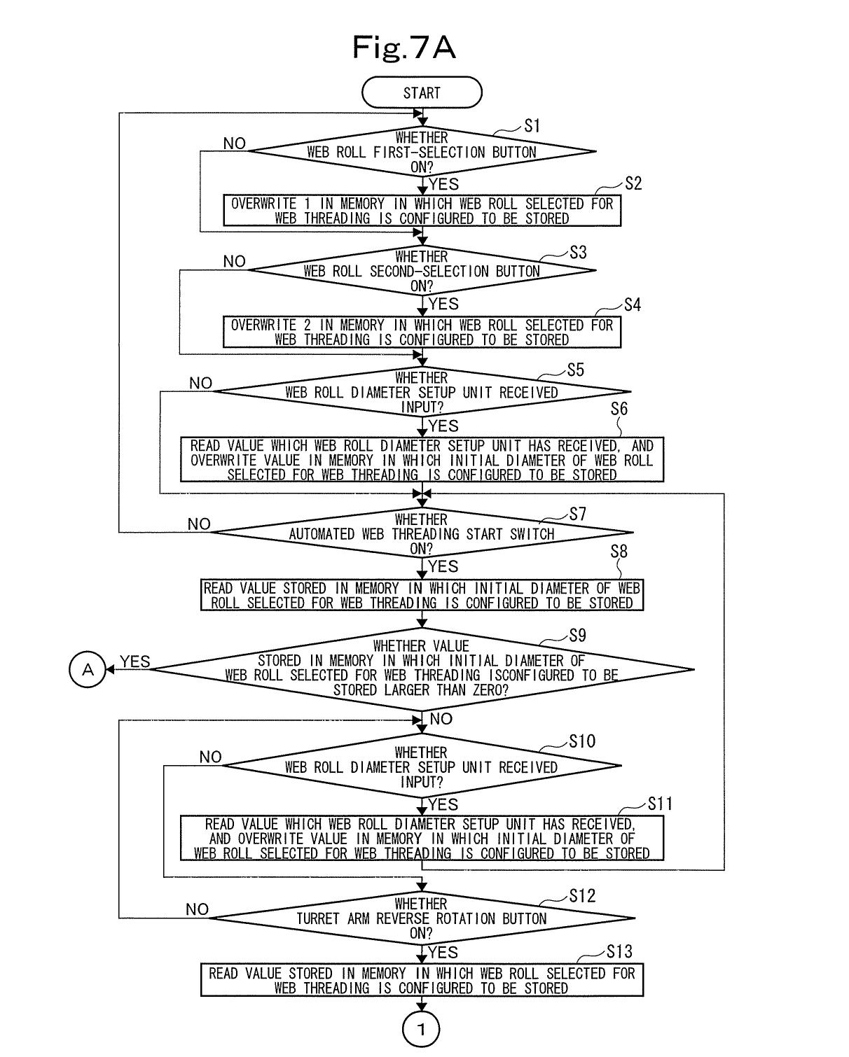

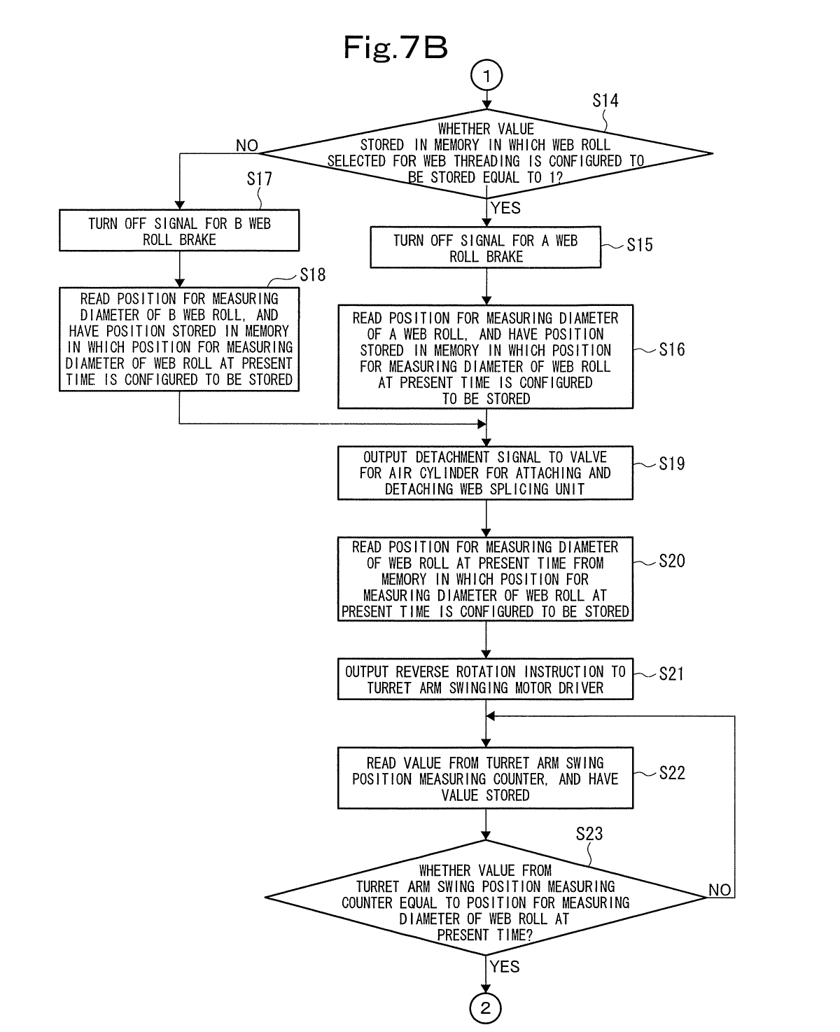

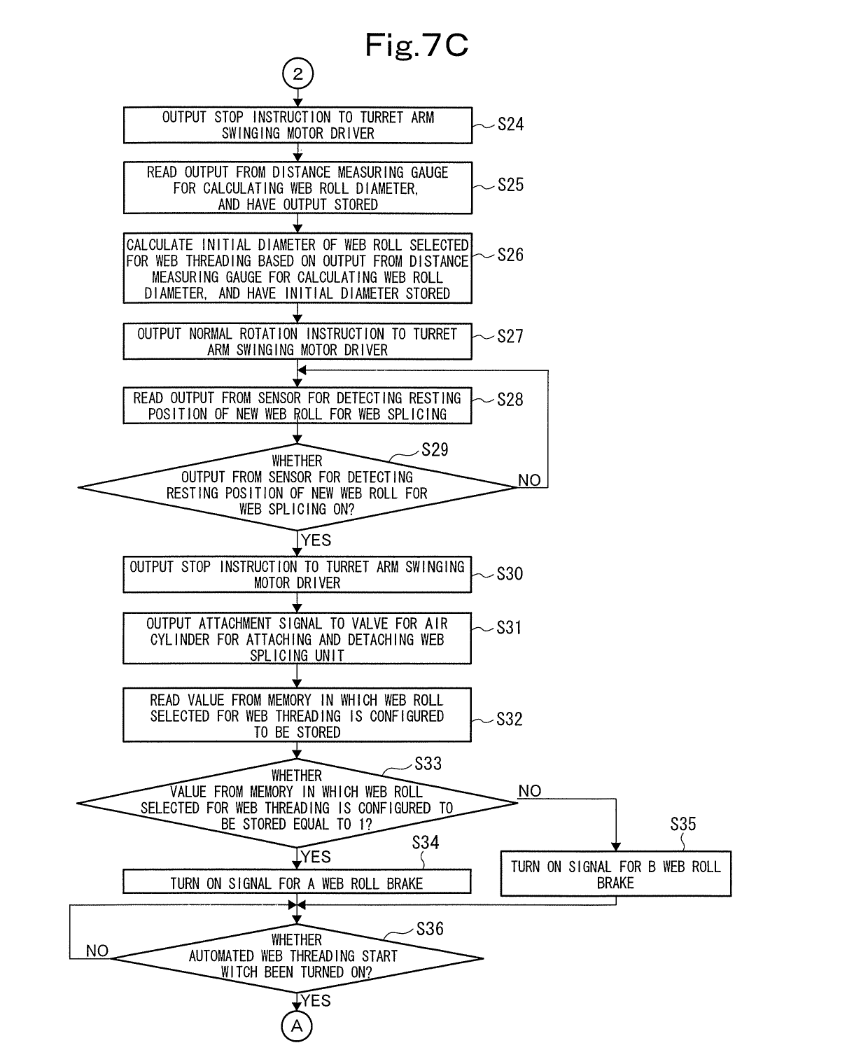

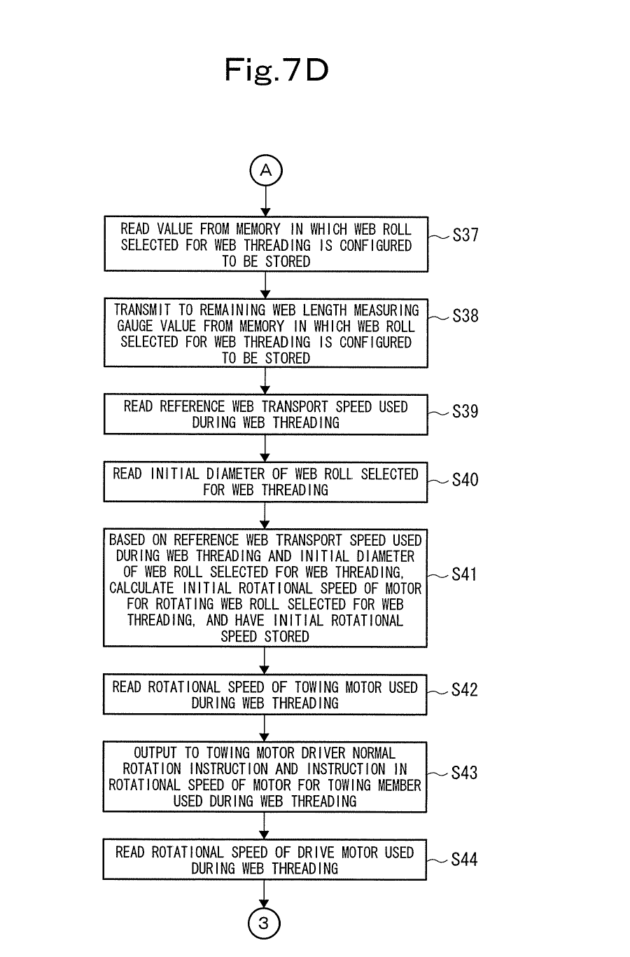

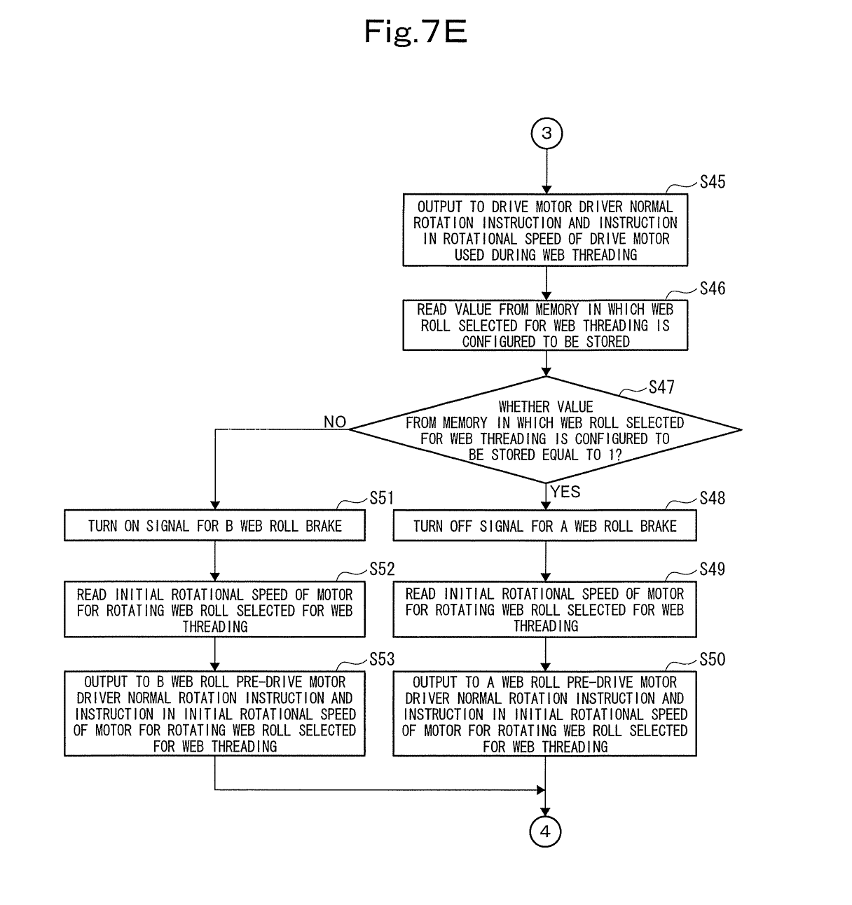

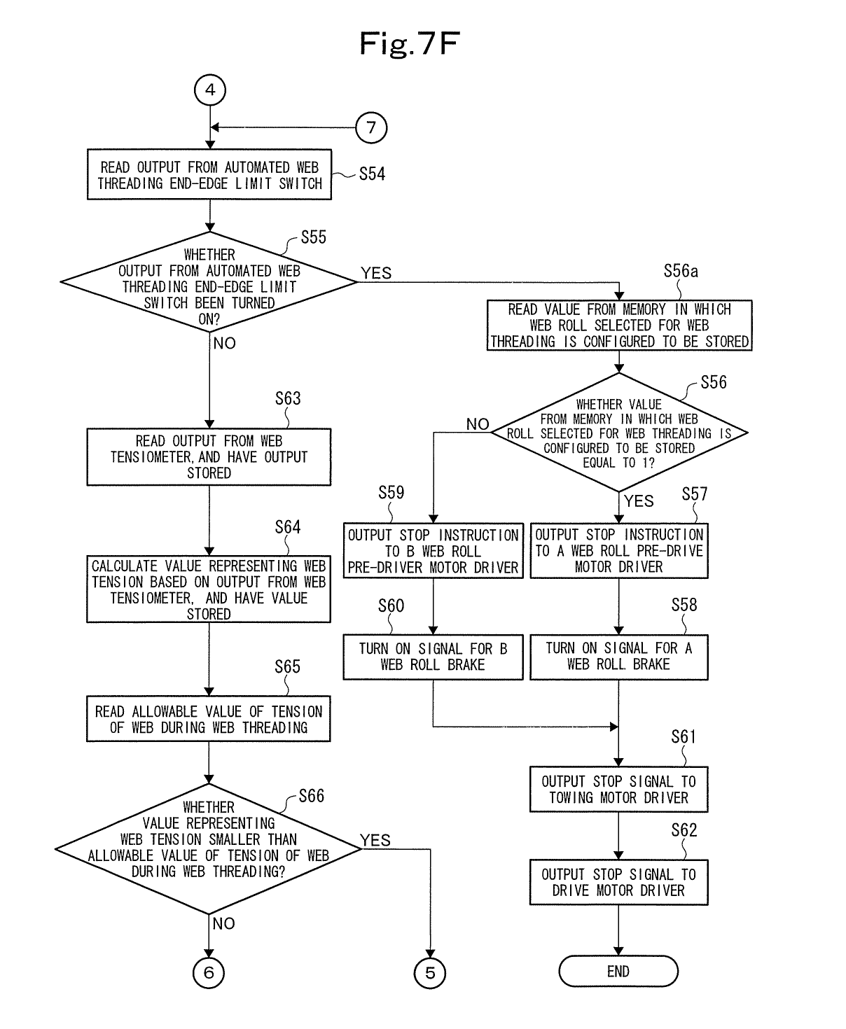

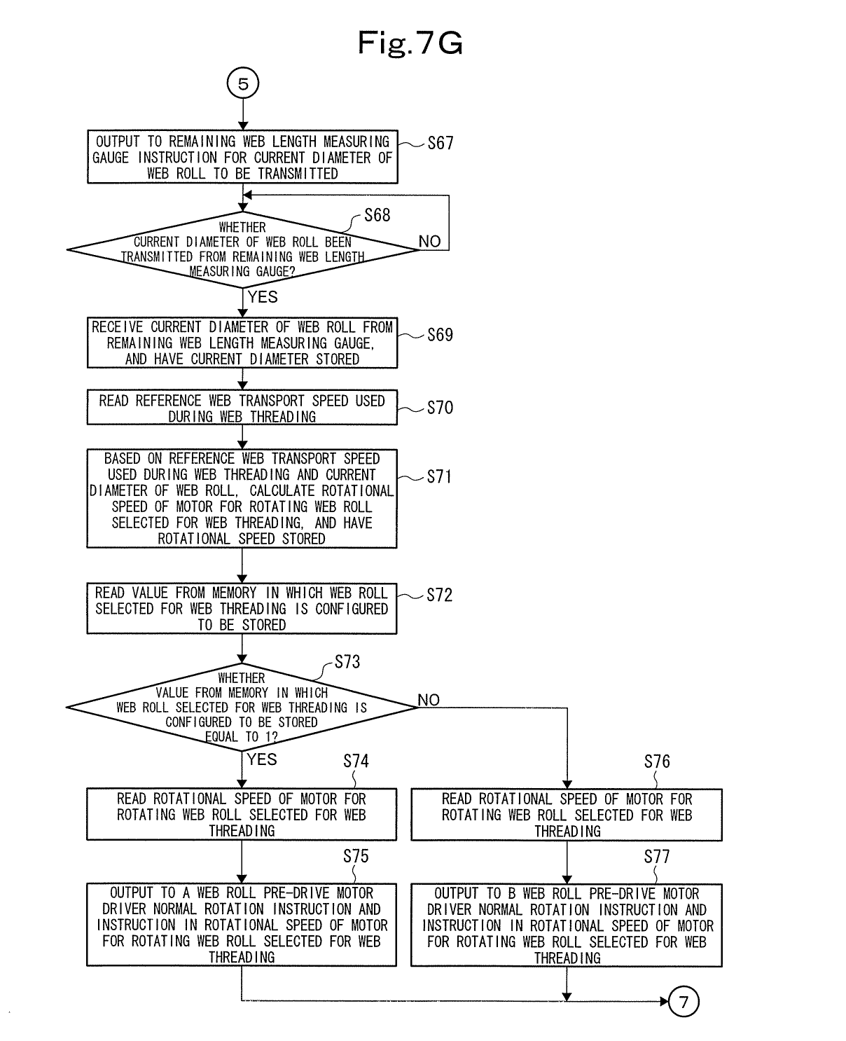

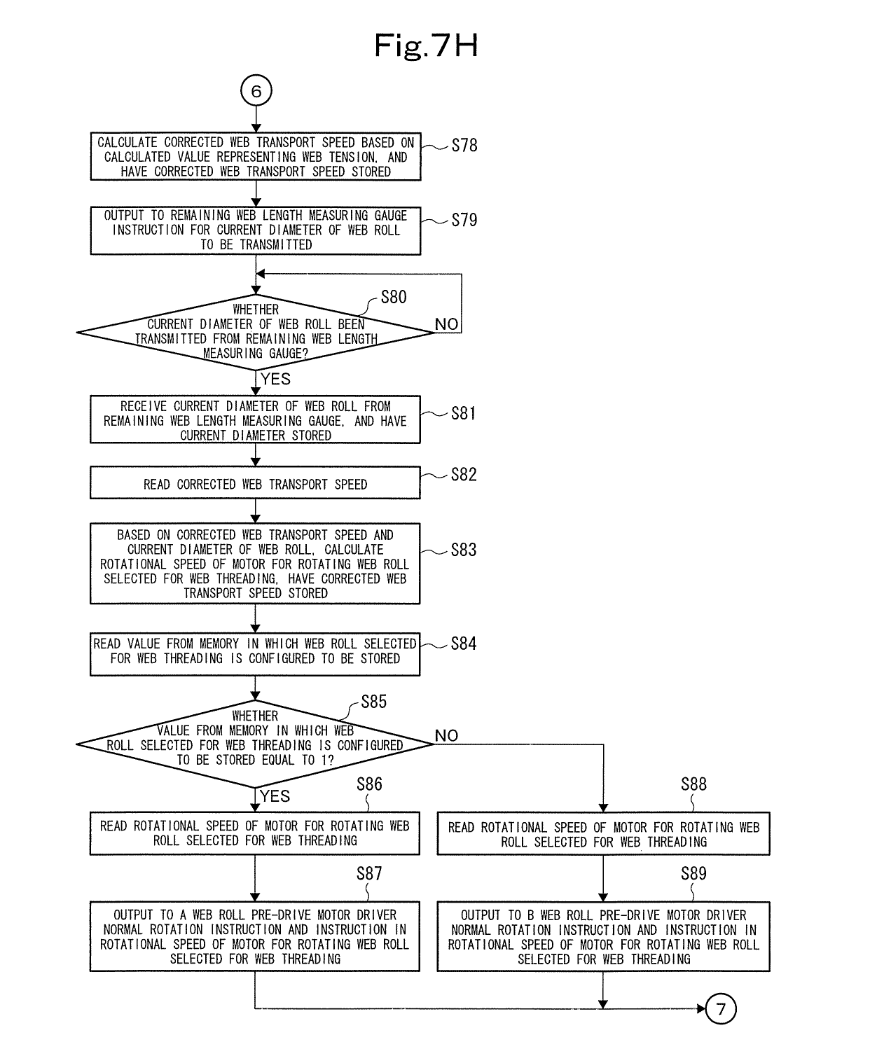

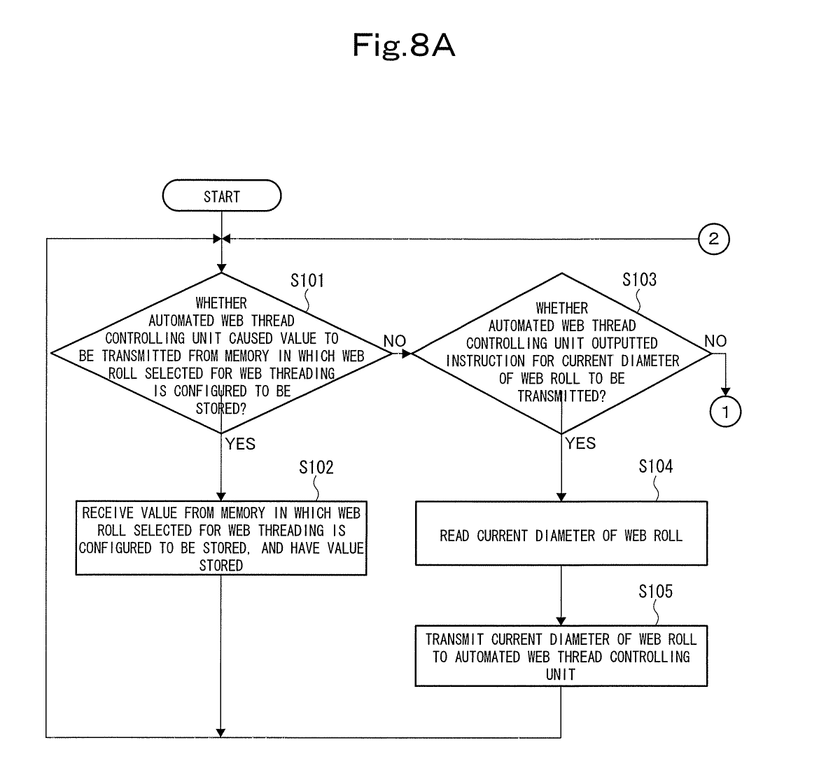

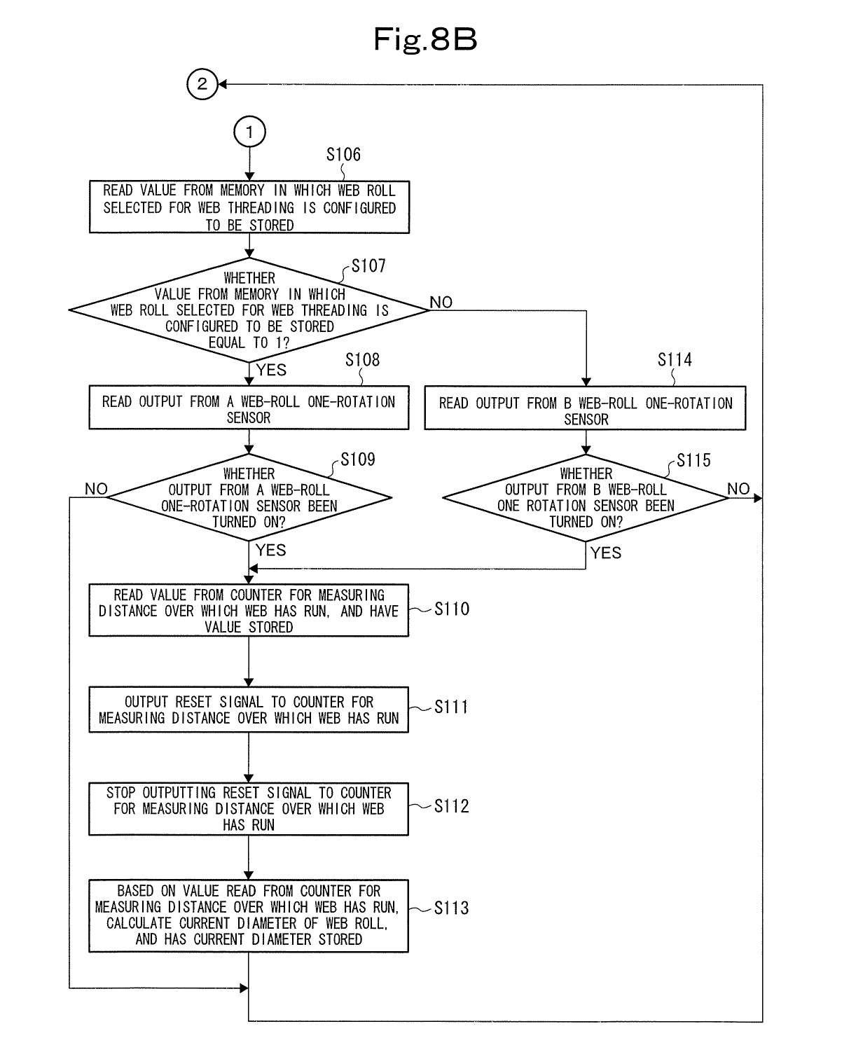

Descriptions will be provided next for how the web is automatically fed to the transport route in the printing press 1 on the basis of the flowcharts shown in FIGS. 7A to 7H and, FIGS. 8A and 8B.

First of all, it is determined whether or not the web roll first-selection button 81a is ON (in step S1). In other words, it is determined whether or not the web roll Wa attached to the A shaft of the turret arm 23 has been selected. In a case where the web roll first-selection button 81a is ON (in a case of YES), this means that the web roll Wa attached to the A shaft of the turret arm 23 has been selected. For this reason, “1” (representing the A shaft) is overwritten in the memory 101 in which a web roll selected for the web threading is configured to be stored (in step S2).

Subsequently, it is determined whether or not the web roll second-selection button 81b is ON (in step S3). In other words, it is determined whether or not the web roll Wb attached to the B shaft of the turret arm 23 has been selected. In a case where a result of the determination in step S1 has been YES, a result of the determination in step S3 is NO. Thus, the process skips step S4, and proceeds to step S5. In a case where a result of the determination in step S1 is NO, or in a case where it is determined that the web Wa attached to the A shaft has not been selected, the process skips step S2, and proceeds to step S3. Thus, it is determined whether or not the web roll second-selection button 81b is ON. In a case where the web roll second-selection button 81b is ON, this means that the web roll Wb attached to the B shaft of the turret arm 23 has been selected. For this reason, “2” (representing the B shaft) is overwritten in the memory 101 in which the web roll selected for the web threading is configured to be stored. In this manner, “1” and “2” which are overwritten in the memory 101 in which the web roll selected for the web threading is configured to be stored are used as flags indicating which web roll has been selected. In a case shown in FIG. 3, the web roll Wb attached to the B shaft has been selected, and the web W of the web roll Wa attached to the A shaft is going to be spliced to the web W of the web roll Wb. For this reason, the web roll second-selection button 81b is selected.

Thereafter, it is determined whether or not the web roll diameter setup unit 85 has received an input (in step S5). The web roll diameter setup unit 85 is designed so that an operator can input a web roll diameter to the web roll diameter setup unit 85. For this reason, an operator can measures the diameter of the web roll, and can input the diameter to the web roll diameter setup unit 85. Otherwise, if there is a record on a web roll diameter available, an operator can input the web roll diameter to the web roll diameter setup unit 85 on the basis of the record. In a case where a web roll diameter has been set up in the web roll diameter setup unit 85, or in a case where the web roll diameter setup unit 85 has received an input, the setup value is read, and is stored in the memory 102 in which an initial diameter of the web roll selected for the web threading is configured to be stored (in step S6). In a case where a setup value has been already stored in the memory 102 in which an initial diameter of the web roll selected for the web threading is configured to be stored, the setup value is overwritten with a new value.

Afterward, it is determined whether or not the automated web threading start switch 82 is ON (in step S7). In a case where a result of the determination in step S5 is NO, or in a case where it is determined that the web roll diameter setup unit 85 has received no input, as well, the process skips step S6, and proceeds to step S7. In the case where the result of the determination in step S7 is not ON, this means that the automated web threading start switch 82 is OFF. For this reason, the automated web threading is not started, and thus the process returns to step S1.

In a case where a result of the determination in step S7 is ON, this means that an instruction to start the automated web threading has been issued. For this reason, a web roll diameter stored in the memory 102 in which an initial diameter of the web roll selected for the web threading is configured to be stored is subsequently read (in step S8). After that, it is determined whether or not the value thus read is larger than zero (in step S9). In a case where the value thus read is larger than zero (in a case of YES), this means an operator has set up the web roll diameter at the value. For this reason, the feeding of the web for the automated web threading is controlled on the basis of the value (or the process proceeds to steps after reference numeral A in FIG. 7D).

In a case where the value thus read is equal to zero, this means that no web roll diameter has been set up in the web roll diameter setup unit 85. For this reason, a web roll diameter is measured by use of the method and the device according to the present invention before the automated web threading is started. First of all, it is determined whether or not an operator has inputted a web roll diameter to the web roll diameter setup unit 85 (in step S10). In other words, it is determined whether or not the operator has inputted a web roll diameter thereto since then. In a case where the operator has inputted a web roll diameter thereto, the web roll diameter is overwritten in the memory 102 in which an initial diameter of the web roll selected for the web threading is configured to be stored (in step S11). Thereafter, the process returns to step S7, where it is determined whether or not the automated web threading start switch 82 is ON. In this case, the process proceeds to steps after reference numeral A after the steps S8 and S9 are carried out, as described above.

In the case where the web roll diameter setup unit 85 has received no web roll diameter, this means that the operator has inputted no web roll diameter yet. In this case, the turret arm 23 needs to be moved to the predetermined position for measuring a web roll diameter for the purpose of newly measuring the diameter of the web roll. To this end, the turret arm 23 needs to be reversed. First of all, it is determined whether or not the turret arm reverse rotation button 84 is ON (in step S12). In a case where the turret arm reverse rotation button 84 is not ON, the process returns to step S10. In a case where the turret arm reverse rotation button 84 is ON, a value stored in the memory 101 in which a web roll selected for the web threading is configured to be stored is read (in step S13).

As shown in FIG. 7B, whether the web roll Wa attached to the A shaft or the web roll Wb attached to the B shaft has been selected is determined depending on whether or not the value thus read is equal to “1” (in step S14). In a case where the web roll attached to the A shaft has been selected, the A web roll brake 28a attached to the A web roll pre-drive motors 26a for the web roll Wa attached to the A shaft is turned OFF (in step S1) so as for the web roll Wa to rotate freely.

Subsequently, the position for measuring the diameter of the A web roll is read from the memory 103a in which the position for measuring the diameter of the A web roll is configured to be stored. Thereafter, the position for measuring the diameter of the A web roll is stored in the memory 104 in which the position for measuring the diameter of the web roll at the present time is configured to be stored (in step S16). In should be noted that the position for measuring the diameter of the A web roll which is stored in the memory 103a in which the position for measuring the diameter of the A web roll is in the form of a value obtained by converting the position for measuring the diameter of the A web roll to a counter value to be outputted from the turret arm swing position measuring counter 68. The turret arm swing position measuring counter 68 is an up/down counter configured to rotate according to the rotation of the turret arm swinging motor 24, and to be reset by a zero pulse outputted from the encoder 25 once each time the turret arm makes one rotation. The turret arm swing position measuring counter 68 is configured to count up clock pulses which are outputted from the encoder 25 when the turret arm swinging motor 24 makes normal rotations, and to count down clock pulses which are outputted from the encoder 25 when the turret arm swinging motor 24 makes reverse rotations. Thus, the turret arms swing position measuring counter 68 is configured to always indicate the swing position of the turret arm.

In a case where a result of the determination in step S14 is NO, this means that a web roll selected for the web threading is on the B shaft. For this reason, the B web roll brake 28b attached to the B web roll pre-drive motors 26b for the web roll Wb attached to the B shaft is turned OFF (in step S17) so as for the web roll Wb to rotate freely. Subsequently, the position for measuring the diameter of the B web roll is read from the memory 103b in which the position for measuring the diameter of the B web roll is configured to be stored. Thereafter, the position for measuring the diameter of the A web roll is stored in the memory 104 in which the position for measuring the diameter of the web roll at the present time is configured to be stored (in step S18). These steps are similar to steps S15 and S16.

After that, the valve 32a is controlled so as to actuate the air cylinder 32 for attaching and detaching the web splicing unit. The air cylinder 32 for attaching and detaching the web splicing unit is actuated in a way that the web splicing unit 31 comes to the resting position indicated by the long dashed double-short dashed line in FIG. 3 (in step S19). The reason why the web splicing unit 31 is moved to the resting position in this manner is that the turret arm 23 and the web roll Wb is intended not to contact the web splicing unit 31 while moving the web roll Wb to the position from which the distance of the web roll Wb can be measured by use of the distance measuring gauge 41 (the position about reference numeral 01 in FIG. 3) for the purpose of measuring the diameter of the web roll Wb as described below.

Subsequently, the position for measuring the diameter of the web roll at the present time is read from the memory 104 in which the position for measuring the diameter of the web roll at the present time is configured to be stored (in step S20). Thereafter, a reverse rotation instruction is outputted to the turret arm swinging motor driver 67 (in step S21). Thus, the turret arm swinging motor 24 is driven. Hence, the turret arm 23 is swung by the drive of the turret arm swinging motor 24.

In conjunction with the swing of the turret arm 23, the position of the turret arm 23 is read by the turret arm swing position measuring counter 68 by use of the rotary encoder 25 attached to the turret arm swinging motor 24. The position of the turret arm 23 thus read is stored in the memory 105 in which a counter value from the turret arm swing position measuring counter is configured to be stored (in step S22).

Thereafter, a counter value from the turret arm swing position measuring counter 68 is compared with the position for measuring the diameter of the web roll at the present time (in step S23). In a case where the counter value does not agree with the position for measuring the diameter of the web roll at the present time (in a case of NO), counter values are repeatedly read from the turret arm swing position measuring counter 68, and are compared with the position for measuring the diameter of the web roll at the present time, until a counter value agrees with the position for measuring the diameter of the web roll at the present time. Once a counter value agrees with the position for measuring the diameter of the web roll at the present time, or once the turret arm 23 has been moved to the position for measuring the web roll diameter at the present time (the position of the web roll Wa indicated by the long dashed double-short dashed line in FIG. 3), a stop instruction is outputted to the turret arm swinging motor driver 67 as shown in FIG. 7C (in step S24). Thus, the turret arm 23 is stopped in the diameter measuring position.

Afterward, the diameter of the web roll Wb which has come to the diameter measuring position is measured. In other words, the distance L2 between the surface of the web roll Wb and the distance measuring gauge 41 for calculating a web roll diameter is measured by the distance measuring gauge 41 for calculating a web roll diameter. The output from the distance measuring gauge 41 for calculating a web roll diameter is converted from an analog value to a digital value by the A/D converter 61. Thereafter, the resultant digital value is read and stored in the memory 106 in which the output from the distance measuring gauge 41 is configured to be stored (in step S25). Subsequently, the diameter d1 of the web roll Wb is found in the foregoing manner from the distance L2 as the result of this detection and the already-known distance L1 between the distance measuring gauge 41 and the center 01 about which the web roll Wb is supported. Afterwards, the diameter d1 of the web roll Wb is stored (in step S26). It should be noted that, although FIG. 3 shows the procedure in which the diameter of the new web roll Wa is measured, this measurement procedure can be applied to the diameter of the web roll Wb.

Once the measurement of the initial diameter of the web roll Wb is completed, the web roll Wa is moved to the position (resting position for web splicing) for splicing the web of the web roll Wa to the web of the web roll Wb. To this end, a normal rotation instruction is outputted to the driver 67 for the turret arm swinging motor 24 (in step S27). On reception of the instruction from the turret arm swing motor driver 67, the turret arm 23 is swung in order that the center of the reel in the A shaft can be moved to the position denoted by reference numeral 02. In other words, the web roll Wb and the web roll Wa change their positions. In addition, the web roll Wa is moved to the position indicated by the solid line in FIG. 3.

For the purpose of determining whether or not the web roll Wa has been moved to the resting position, an output from the resting position sensor 40 is read (in step S28), and thus it is determined whether or not the output from the sensor 40 becomes ON (in step S29). Until an output from the resting position sensor 40 becomes ON, outputs from the resting position sensor 40 are repeatedly read. Once the web roll Wa has come to the resting position for the web splicing, an output from the resting position sensor 40 becomes ON. The turret arm 23 continues being swung until the resting position sensor 40 outputs ON.

Once the resting position sensor 40 outputs ON, a stop instruction is outputted to the driver 67 for the turret arm swinging motor 24. Thus, the turret arm swinging motor 24 is stopped (in step S30).

Subsequently, the web splicing unit 31 is driven. The web splicing unit 31 is driven by giving an attachment instruction to the valve 32a of the air cylinder 32 for attaching and detaching the web splicing unit (in step S31). Because of this attachment instruction, for example, the valve 32a is switched in a direction which makes the air cylinder 32 for attaching and detaching the web splicing unit contract. Thus, the air cylinder 32 for attaching and detaching the web splicing unit is driven as shown by the solid line in FIG. 3. Hence, the web splicing unit 31 is moved to the attachment position. What is aimed at by beforehand moving the new web roll Wa to the web splicing position is to make it possible to thread the web immediately once the web needs to be threaded while the printing press is actually operated after the web of the old web roll Wb is threaded.

Subsequently, a value stored in the memory in which a web roll selected for the web threading is configured to be stored is read (in step S32). Thereafter, it is determined whether a web roll selected for the web threading is that attached to the A shaft or the B shaft of the turret arm 23 (in step S33). In a case where a web roll selected for the web threading is attached to the A shaft, or in a case where a result of the determination in step S33 is YES, a signal is outputted for turning ON the A web roll brake 28a of the A web roll pre-drive motor 26a attached to the A shaft. Thus, the A web roll pre-drive motor 26a is braked (in step S34). In a case where a web roll selected for the web threading is that attached to the B shaft, or in a case where a result of the determination in step S33 is NO, a signal is outputted for turning on the B web roll brake 28b of the B web roll pre-drive motor 26b attached to the B shaft. Thus, the B web roll pre-drive motor 26b is braked (in step S35).

Thereafter, it is determined whether or not the automated web threading start switch 82 is ON. In the case where the switch is ON, the process proceeds to steps coming after reference numeral A (in FIGS. 7D to 7H) (in step S36). In a case where a result of the determination is NO, the determination is repeated. Preparation for the web threading ends with the foregoing steps.

After that, a value (“1” or “2”) stored in the memory 101 in which a web roll selected for the web threading is configured to be stored is read (in step S37). In other words, it is determined whether the web roll attached to the A shaft of the turret arm 23 or the web roll attached to the B shaft of the turret arm 23 is selected for the web threading. A result of the reading is transmitted to the remaining web length measuring gauge 44 (in step S38). In other words, whether data from the web-roll one-rotation sensor 47a or data from the web-roll one-rotation sensor 47b should be used is determined depending on a value representing the web roll selected for the web threading. That is because the web-roll one-rotation sensors 47a and 47b are provided respectively to the web rolls Wa and Wb.

The reference transport speed which has been beforehand stored in the memory 107 in which the reference web transport speed used during the web threading is configured to be stored is read (in step S39).

Subsequently, the initial diameter of the web roll selected for the web threading, which has been stored in the memory 102 in which the initial diameter of the web roll selected for the web threading is configured to be stored, is read (in step S40).

On the basis of the results of the readings respectively in steps S39 and S40, an initial rotational speed of the web roll pre-drive motor 26a as one of the web roll rotating motors is calculated from the reference transport speed and the initial diameter of the web roll Wa used during the web threading. Subsequently, the initial rotational speed of the web roll pre-drive motor 26a is stored (in step S41). Otherwise, on the basis of the results of the readings respectively in steps S39 and S40, an initial rotational speed of the web roll pre-drive motor 26b as the other one of the web roll rotating motors is calculated from the reference transport speed and the initial diameter of the web roll Wb used during the web threading. Subsequently, the initial rotational speed of the web roll pre-drive motor 26b is stored (in step S41). Thereby, the rotational speeds of the respective web roll pre-drive motors 26a and 26b are found depending on their corresponding web roll diameters.

Afterwards, the rotational speed of the towing motor 13 used during the web threading, which has been stored in the memory 109 in which the rotational speed of the towing motor used during the web threading is configured to be stored, is read (in step S42). In a case where the rotational speed of the web W used for the web threading is set at a constant rate, a constant speed of the towing motor 13 is read.

On the basis of the speed of the towing motor 13 used during the web threading which has been thus read, a normal rotation instruction and an instruction on the rotational speed are outputted to the towing motor driver 16 (in step S43). Thereby, the towing motor 13 is driven, and thus the holder 14 which holds the forward edge of the web W is moved at a constant speed.

The rotational speed of the drive motor 70 used during the web threading, which has been stored in the memory 110 in which the rotational speed of the drive motor used during the web threading is configured to be stored, is read (in step S44). On the basis of the rotational speed thus read, a normal rotation instruction and an instruction on the rotational speed are outputted to the drive motor driver 71 as shown in FIG. 7E (in step S45). Thus, the drive motor 70 is driven at the predetermined rotational speed used during the web threading via the drive motor driver 71. Although the drive motor 70 is that for driving the printing press itself, the drive motor 70 is driven during the web threading as well. What is aimed at by driving the drive motor 70 during the web threading is to prevent the web W selected for the web threading from contacting, and being rubbed by, rollers in a halt state in the printing press.

Subsequently, a memory value (“1” or “2”) stored in the memory 101 in which the web roll selected for the web threading is configured to be stored is read (in step S46). Thereafter, it is determined whether or not the memory value is equal to “1” (in step S47). In a case where the memory value is equal to “1,” this means that the web roll Wa attached to the A shaft is selected for the web threading. For this reason, the web roll brake 28a of the A web roll pre-drive motor 26a is turned OFF, and thus the A web roll pre-drive motor 26a is capable of being rotated and driven (in step S48).

Afterward, the initial rotational speed of the motor for rotating the web roll Wa stored in the memory 108 in which the initial rotational speed of the motor for rotating the web roll selected for the web threading is configured to be stored, is read (in step S49). Thus, a normal rotation instruction and an instruction on the rotational speed are outputted to the A web roll pre-drive motor driver 69a (in step S50).

In a case where it is determined in step S 47 that the memory value is not equal to “1,” this means that the web roll Wb attached to the B shaft has been selected for the web threading. For this reason, the web roll brake 28b of the B web roll pre-drive motor 26b is turned OFF (in step S51), and thus the B web roll pre-drive motor 26b is capable of being rotated and driven. Subsequently, the initial rotational speed of the motor for rotating the web roll Wb stored in the memory 108 in which the initial rotational speed of the motor for rotating the web roll selected for the web threading is configured to be stored, is read (in step S52). Thus, a normal rotation instruction and an instruction on the rotational speed are outputted to the B web roll pre-drive motor driver 69b (in step S53).

As described above, the holder 14 which holds the forward edge of the web W is moved by the drive of the towing motor 13. In addition, the web roll Wa is unwound by the rotation of the web roll pre-drive motor 26a. Otherwise, the web roll Wb is unwound by the rotation of the web roll pre-drive motor 26B. Thereby, the web W is automatically fed along the transport route.

Afterward, as shown in FIG. 7F, an output from an automated web threading end-edge limit switch 66, which is arranged in an entrance portion of the folder 8 as the end point of the web threading, is read (in step S54). Thereafter, it is determined whether or not the output from the automated web threading end-edge limit switch 66 is ON (in step S55). In a case where the output from the automated web threading end-edge limit switch 66 is ON, this means that the holder 14 which holds the forward edge of the web has come to the end edge, and that the web threading has been accordingly completed. As a result, all of the driving systems are stopped.

A process for stopping all the driving system is carried out as follows. First of all, it is determined whether the web roll attached to the A shaft or the web roll attached to the B shaft has been used for the web threading. In other words, the memory value (“1” or “2”) stored in the memory 101 in which the web roll selected for the web threading is configured to be stored is read (in step S56a), and it is determined whether or not the memory value is equal to “1” (in step S56). In a case where the memory vale is equal to “1,” this means that the web roll attached to the A shaft has been used. For this reason, a stop instruction is outputted to the A web roll pre-drive motor driver 69a (in step S57). Thus, the A web roll pre-drive motor 26a is stopped. The web roll brake 28a attached to the A shaft is turned ON (in step S58). Hence, the rotation of the A web roll pre-drive motor 26a is stopped. In a case where it is determined in step S56 that the memory value is not equal to “1,” this means that the web roll attached to the B shaft has been used for the web threading. For this reason, a stop instruction is outputted to the web roll pre-drive motor driver 69b attached to the B shaft (in step S59). Hence, the B web roll pre-drive motor driver 26b is stopped. The web roll brake 28b attached to the B shaft is turned ON (in step S60). As a result, the B web roll pre-drive motor 26B is stopped.

After that, a stop instruction is outputted to the towing motor driver 16 (in step S61). Thus, the towing motor 13 is stopped. Subsequently, a stop instruction is outputted to the drive motor driver 71 (in step S62). Hence, the drive motor 70 is stopped.

As described above, once it is determined that the threading of the web W has been completed, all of the driving systems are stopped, and the web threading is completed.

In a case where it is determined in step S55 that the output from the automated web threading end-edge limit switch 66 is not ON, this means that the web threading has not been completed yet. For this reason, tension applied to the web W is controlled so that the web should not be ripped while the web is being threaded.

To this end, an output from the web tensiometer 42 is converted from an analog signal to a digital signal by the A/D converter 65. Thereafter, the resultant output is read, and is stored in the memory 111 in which the output from the web tensiometer is configured to be stored (in step S63). Tension applied to the web W is calculated on the basis of the output from the web tensiometer 42. A calculated value representing the web tension is stored in the memory 112 in which the value representing the web tension is configured to be stored (in step S64). Thereafter, an allowable value of a web tension stored in the memory 113 in which the allowable value of the web tension used during the web threading is configured to be stored is read (in step S65). By comparing the allowable value of the web tension with the calculated value representing the web tension, it is determined whether or not the calculated value of the web tension is smaller than the allowable value of the web tension (in step S66).

In a case where it is determined that the calculated value representing the web tension is smaller than the allowable value of the web tension (in a case where a result of the determination is YES), this means the value representing the tension applied to the web W is below the allowable range of the tension value. For this reason, a control on the basis of the tension is not carried out. Instead, a control is made for feeding out the web on the basis of the diameter of the web roll Wa or Wb. In other words, the rotational speed of the web roll pre-drive motor 26a or 26b is controlled as shown in FIG. 7G.

In a case where the calculated value representing the web tension is smaller than the allowable value of the web tension, or in a case where a result of the determination in step S66 is YES, an instruction is outputted to the remaining web length measuring gauge 44 so that the remaining web length measuring gauge 44 should transmit the current diameter of the web roll (in step S67). Subsequently, it is determined whether or not the current diameter of the web roll has been transmitted out from the remaining web length measuring gauge 44 (in step S68). This determination is repeated until the remaining web length measuring gauge 44 transmits the current diameter of the web roll.

Once the current diameter of the web roll is transmitted out from the remaining web length measuring gauge 44, the current diameter of the web roll is received, and is stored in the memory 115 in which the current diameter of the web roll is configured to be stored (in step S69). Subsequently, a reference web transport speed used during the web threading stored in the memory 107 in which the reference web transport speed used during the web threading is configured to be stored is read (in step S70).

The rotational speed of the web roll pre-drive motor 26a or 26b at which the web roll Wa or Wb selected for the web threading is rotated is calculated on the basis of the current diameter of the web roll and the reference web transport speed used during the web threading which has been read. The rotational speed thus calculated is stored in the memory 116 in which the rotational speed of the motor for rotating the web roll selected for the web threading is configured to be stored (in step S71).

Thereafter, the memory value (“1” or “2”) stored in the memory 101 in which a web roll selected for the web threading is configured to be stored is read (in step S72). Subsequently, it is determined whether or not the memory value thus read is equal to “1.” In other words, it is determined whether or not the web roll Wa attached to the A shaft has been selected (in step S73).

In a case where a result of the determination is YES, this means that the web roll Wa attached to the A shaft has been selected for the web threading. For this reason, the rotational speed of the web roll pre-drive motor 26a or 26b for rotating the web roll Wa or Wb selected for the web threading is read from the memory 116 in which the rotational speed of the motor for rotating the web roll selected for the web threading is configured to be stored (in step S74). After that, the normal rotation instruction and the read instruction on the rotational speed are outputted to the A web roll pre-drive motor driver 69a (in step S75). Thereby, the web roll pre-drive motor 26a attached to the A shaft rotates at the predetermined speed, and thus the web continues being threaded.

In a case where a result of the determination in step S73 is NO, or in a case where the web roll attached to the B shaft has been selected for the web threading, a similar process is applied to the web roll Wb attached to the B shaft. In other words, the rotational speed of the web roll pre-drive motor 26a or 26b for rotating the web roll Wa or Wb selected for the web threading is read from the memory 116 in which the rotational speed of the motor for rotating the web roll selected for the web threading is configured to be stored (in step S76). Afterward, the normal rotation instruction and the read instruction on the rotational speed are outputted to the B web roll pre-drive motor driver 69b (in step S77). Thereby, the web roll pre-drive motor 26b attached to the B shaft rotates at the predetermined speed, and thus the web continues being threaded.

In a case where a result of the determination in step S66 is NO, or in a case where the value representing the measured tension exceeds the allowable tension value, this means that the rotational speed of the web roll Wa or Wb is less than the speed of the holder 14 when using as the reference the speed of the holder 14 which is the towing member. For this reason, a control is carried out so as to increase the rotational speed of the web roll pre-drive motor 26a or 26b for rotating the web roll Wa or Wb. To this end, a corrected transport speed of the web W is calculated for the purpose of correcting the transport speed on the basis of the current tension value. Thereafter, the corrected transport speed is stored in the memory 114 in which the corrected web transport speed is configured to be stored (in step S78).

Afterward, for the purpose of determining how large the current diameter of the web roll Wa or Wb is, an instruction is outputted to the remaining web length measuring gauge 44 so that the remaining web length measuring gauge 44 should transmit the current diameter of the web roll (in step S79). After that, it is determined whether or not the remaining web length measuring gauge 44 has transmitted the current diameter of the web roll (in step S80). The determination is repeated until the remaining web length measuring gauge 44 transmits the current diameter of the web roll.

Once the remaining web length measuring gauge 44 transmits the current diameter of the web roll, the current diameter of the web roll is received, and is stored in the memory 115 in which the current diameter of the web roll is configured to be stored (in step S81).

The corrected web transport speed stored in the memory 114 in which the corrected web transport speed is configured to be stored is read (in step S82). On the basis of this corrected web transport speed and the current diameter of the web roll stored in the memory 115 in which the current diameter of the web roll is configured to be stored, the rotational speed of the web roll pre-drive motor 26a or 26b which is the motor for rotating the web roll selected for the web threading is calculated, and is stored in the memory 116 in which the rotational speed of the motor for rotating the web roll selected for the web threading is configured to be stored (in step S83).

Thereafter, the memory value (“1” or “2”) stored in the memory 101 in which a web roll selected for the web threading is configured to be stored is read (in step S84). Subsequently, it is determined whether or not the memory value thus read is equal to “1.” In other words, it is determined whether or not the web roll Wa attached to the A shaft has been selected (in step S85).

In a case where a result of the determination is YES, this means that the web roll Wa attached to the A shaft has been selected for the web threading. For this reason, the rotational speed of the web roll pre-drive motor 26a or 26b for rotating the web roll Wa or Wb selected for the web threading is read from the memory 116 in which the rotational speed of the motor for rotating the web roll selected for the web threading is configured to be stored (in step S86). After that, the normal rotation instruction and the read instruction on the rotational speed are outputted to the A web roll pre-drive motor driver 69a (in step S87). Thereby, the web roll pre-drive motor 26a attached to the A shaft rotates at the predetermined speed, and thus the web continues being threaded.

In a case where a result of the determination in step S85 is NO, or in a case where the web roll attached to the B shaft has been selected for the web threading, a similar process is applied to the web roll Wb attached to the B shaft. In other words, the rotational speed of the web roll pre-drive motor 26a or 26b for rotating the web roll Wa or Wb selected for the web threading is read from the memory 116 in which the rotational speed of the motor for rotating the web roll selected for the web threading is configured to be stored (in step S88). Afterward, the normal rotation instruction and the read instruction on the rotational speed are outputted to the B web roll pre-drive motor driver 69b (in step S89). Thereby, the web roll pre-drive motor 26b attached to the B shaft rotates at the predetermined speed, and thus the web continues being threaded.

As described above, the rotational speed of the web roll Wa or Wb selected for the web threading is adjusted by controlling the web roll pre-drive motor 26a or 26b, and thus the web is threaded with no excessive tension applied to the web W, in steps S75, S77, S87 and S89. The processes to be carried out in steps S54 to S89 are repeated. Once the automated web threading end-edge limit switch 66 becomes ON in step S55, the web threading is completed as described above.

Descriptions will be provided next for what process the remaining web length measuring gauge 44 as shown in FIG. 4 carries out for the web threading on the basis of the FIG. 6 and FIGS. 8A to 8B. The remaining web length measuring gauge 44 is primarily that for measuring the amount of remaining web of each of the web rolls Wa and Wb which are being unwound, and for thus determining whether or not the amount of remaining web becomes small enough for the other web to be spliced thereonto. For the web threading, however, the remaining web length measuring gauge 44 is used as means for measuring the diameter of the web roll after the web starts to be threaded as described below.

First of all, it is determined whether or not the automated web thread controlling unit 15 has caused the memory value (“1” or “2”) to be transmitted from the memory 101 in which the web roll selected for the web threading is configured to be stored (in step S101). In a case where a result of the determination is YES, the value is stored in the memory 129 in which the web roll selected for the web threading is configured to be stored (in step S102). To put it the other way round, steps S101 and S102 constitutes only a loop in which it is determined which web roll has been selected for the web threading, and in which a result of the determination is stored in the memory.

In a case where a result of the determination in step S101 is NO, it is determined whether or not the automated web thread controlling unit 15 has outputted an instruction for the current diameter of the web roll to be transmitted (in step S103). This transmission instruction is issued in steps S67 and S79 in the main flow as shown in FIGS. 7A to 7H. In a case where the transmission instruction has been issued, the current diameter of the web roll stored in the memory 131 in which the current diameter of the web roll is configured to be stored is read (in step S104). Thereafter, the current diameter of the web roll is transmitted to the control unit 15 in the automated web threading device 11 (in step S105). This current diameter of the web roll is stored in the memory 115 in which the current diameter of the web roll is configured to be stored in the automated web thread controlling unit 15.

In a case where a result of the determination in step S103 is NO, a memory value (“1” or “2”) stored in the memory 129 in which a web roll selected for the web threading is configured to be stored is read (in step S106). In other words, it is determined whether the web roll Wa attached to the A shaft of the turret arm 23 or the web roll Wb attached to the B shaft of the turret arm 23 has been selected for the web threading.

It is determined whether or not the memory value stored in the memory 129 in which the web roll selected for the web threading is configured to be stored is equal to “1” (in step S107). In a case where a result of the determination is YES, or in a case where the memory value is equal to “1,” this means that the web roll Wa attached to the A shaft has been selected for the web threading. For this reason, an output from the web-roll one-rotation sensor 47a assigned to the web roll Wa attached to the A shaft is read (in step S108).

Subsequently, it is determined whether or not the output from the web-roll one-rotation sensor 47a attached to the A shaft is turned ON (in step S109). In a case where a result of the determination is YES, or in a case where the output from the web-roll one-rotation sensor 47a attached to the A shaft is ON, a value indicated by the counter 48 for measuring an aggregate distance over which the web has run is read. Thus, the value thus read is stored in the memory 130 in which the value from the counter for measuring a distance over which the web has run is configured to be stored (in step S110).

Afterward, a reset signal is outputted to the counter 48 for measuring an aggregate distance over which the web has run for the purpose of resetting the counter 48 for measuring an aggregate distance over which the web has run (in step S111). Thereafter, the reset signal to the counter 48 for measuring an aggregate distance over which the web has run is stopped (in step S112).

On the basis of the value read from the counter 48 for measuring an aggregate distance over which the web has run in step S110, the current diameter of the web roll is calculated, and is stored in the memory 131 in which the current diameter of the web roll is configured to be stored (in step S113). The diameter of the web roll is calculated on the basis of the pulse P1 from the web-roll one-rotation sensor 47a (47b) and the pulse P2 from the rotary encoder 46, as described above.

In a case where it is determined in step S107 that the memory value is not equal to “1,” or in a case where it is determined in step S107 that the web roll Wb attached to the B shaft has been selected for the web threading, an output from the web-roll one-rotation sensor 47b assigned to the web roll Wb attached to the B shaft is read (in step S114). Thereby, it is determined whether or not the output from the web-roll one-rotation sensor 47b attached to the B shaft has turned ON (in step S115). In a case where a result of the determination is YES, the processes in and after S110 are carried out.

In a case where it is determined in step S109 that the output from the web-roll one-rotation sensor 47a is not ON, or in a case where the result of the determination in step S109 is NO, the process returns to START. In a case where it is determined in step S115 that the output from the web-roll one-rotation sensor 47b is not ON, or in a case where the result of the determination in step S115 is NO, the process returns to START.

Through the foregoing steps, the current diameter of the web roll which is changing in each rotation of the web roll is stored in the memory 131 in which the current diameter of the web roll is configured to be stored. For this reason, in a case where it is determined in step S103 that the automated web thread controlling unit 15 has outputted the instruction for the current diameter of the web roll to be transmitted, the current diameter of the web roll is read from the memory 131 in which the current diameter of the web roll is configured to be stored. Thereafter, the current diameter of the web roll is transmitted to the automated web thread controlling unit 15.

### Embodiment 2

Descriptions will be provided next for another embodiment of the present invention.

Embodiment 1 is carried out with a consideration given to the case where an operator inputs an initial diameter of the web roll manually. However, such a manual input work is eliminated from Embodiment 2. In the case of Embodiment 2, once a process for threading a web is started, the diameter of the web roll is designed to automatically start to be measured.

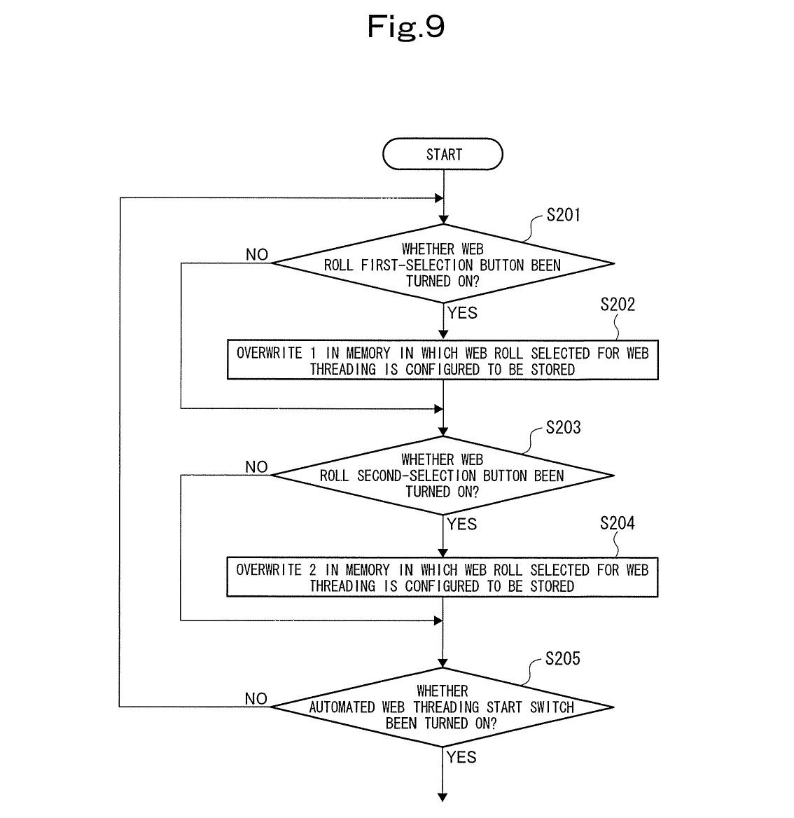

In the case of this embodiment, steps S1 to S12 in the flow as shown in FIG. 7A is modified to steps S201 to S205 in the flow as shown in FIG. 9. That is because the diameter of the web roll is designed to automatically start to be measured.

Once the process is started, first of all, it is determined whether or not the web roll first-selection button 81a is ON (in step S201). In other words, it is determined whether or not the web roll Wa attached to the A shaft of the turret arm 23 has been selected. In a case where the web roll first-selection button 81a is ON (in a case of YES), this means that the web roll Wa attached to the A shaft of the turret arm 23 has been selected. For this reason, “1” (representing the A shaft) is overwritten in the memory 101 in which the web roll selected for the web threading is configured to be stored (in step S202). Subsequently, it is determined whether or not the web roll second-selection button 81b is ON (in step S203). In other words, it is determined whether or not the web roll Wb attached to the B shaft of the turret arm 23 has been selected. In a case where a result of the determination in step S201 has been YES, a result of the determination in step S203 is NO. Thus, the process skips step S204, and proceeds to step S205. In a case where a result of the determination in step S201 is NO, or in a case where it is determined that the web Wa attached to the A shaft has not been selected, the process skips step S202, and proceeds to step S203. Thus, it is determined whether or not the web roll second-selection button 81b is ON. In a case where the web roll second-selection button 81b is ON, this means that the web roll Wb attached to the B shaft of the turret arm 23 has been selected. For this reason, “2” (representing the B shaft) is overwritten in the memory 101 in which the web roll selected for the web threading is configured to be stored (in step S204).

Whether the web roll selected for the web threading is that attached to the A shaft or the B shaft is stored. Thereafter, it is determined whether or not the automated web threading start switch 82 is ON (in step S205). After that, the same process as those of Embodiment 1 described above is carried out except for the process for controlling tension which will be described below (the step S67 and the steps after S67 in FIG. 7H). In other words, the processes of and after automatically measuring the diameter are carried out immediately after determining whether the web roll selected for the web threading is that attached to the A shaft or the B shaft.

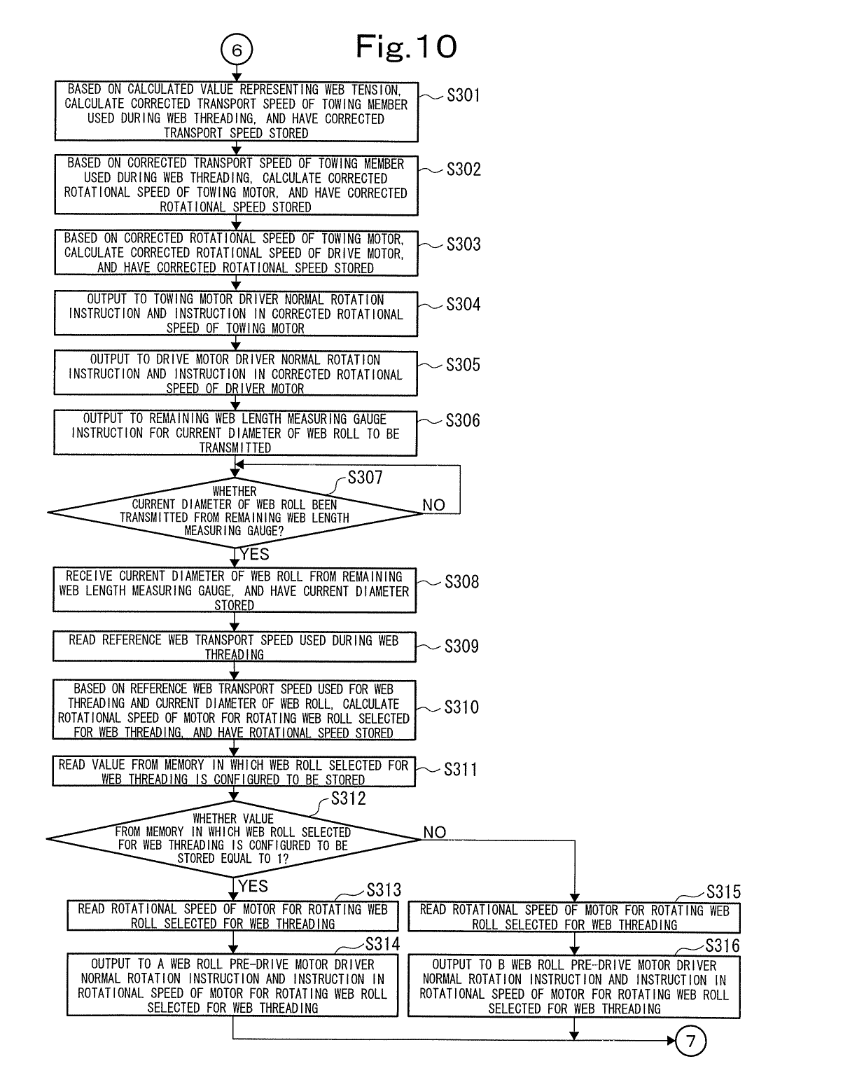

In the case of Embodiment 1, when the value representing the web tension exceeds the allowable value during the web threading, the rotational speed of any one of the web roll pre-drive motors 26a and 26b for rotating the respective the web rolls Wa and Wb is controlled, and thereby the value representing the web tension is controlled so that the value can fall within the allowable range. In contrast, in the case of Embodiment 2, the towing speed of the holder 14 is controlled, and thereby the value representing the web tension is controlled so that the value can fall within the allowable range. To this end, as shown in FIG. 5B, the apparatus according to Embodiment 2 further includes a memory 141 in which a corrected transport speed of the towing member during the web threading is configured to be stored, a memory 142 in which a corrected rotational speed of the motor for the towing member is configured to be stored, and a memory 143 in which a corrected rotational speed of the drive motor is configured to be stored. The corrected transport speed of the holder 14 as the towing member during the web threading is stored in the memory 141. The corrected rotational speed of the motor 13 for driving and rotating the holder 14 as the towing member is stored in the memory 142. The corrected rotational speed of the drive motor 70 is stored in the memory 143. In addition, the contents of the control are reflected on the change from steps S78 to S89 shown in FIG. 7H to steps S301 to S316 shown in FIG. 10.

In a case where it is determined that a calculated value of the web tension is not smaller than the allowable value of the web tension, or in a case where it is determined that a calculated value of the web tension exceeds the allowable value of the web tension (in a case where a result of the determination in step S66 in FIG. 7F is NO), the transport speed of the holder 14 is corrected in order to reduce the transport speed of the web W. In other words, on the basis of the current calculated value of the web tension, a corrected transport speed of the holder 14 during the web threading is calculated. Thereafter, the corrected transport speed thus calculated is stored in the memory 141 in which the corrected transport speed of the towing member during the web threading is configured to be stored (in step S301).

On the basis of the corrected transport speed of the holder 14 during the web threading, a corrected rotational speed of the towing motor 13 is calculated. Thereafter, the corrected rotational speed thus calculated is stored in the memory 142 in which the corrected rotational speed of the motor for the towing member is configured to be stored (in step S302). The speed at which the holder 14 tows the web W is intended to be changed. For this reason, the rotational speed of the rollers (cylinders) of the printing press needs to be accordingly changed. To this end, on the basis of the corrected rotational speed of the towing motor 13, a corrected rotational speed of the driver motor 70 is calculated. Thereafter, the corrected rotational speed thus calculated is stored in the memory 143 in which the corrected rotational speed of the drive motor is configured to be stored (in step S303).

A normal rotation instruction and an instruction for the towing motor to rotate at the corrected rotational speed are outputted to the towing motor driver 16 (in step S304). In other words, the corrected rotational speed of the towing motor 13 stored in the memory 142 in which the corrected rotational speed of the towing motor is configured to be stored is read, and is outputted to the towing motor driver 16. Subsequently, a normal rotation instruction and an instruction for the drive motor to rotate at the corrected rotational speed are outputted to the drive motor driver 71 (in step S305). Specifically, the corrected rotational speed of the drive motor stored in the memory 143 in which the corrected rotational speed of the drive motor is configured to be stored is read, and is outputted to the drive motor driver 71. Thus, the holder 14 is moved at the corrected transport speed. This precludes excessive tension from being applied to the web W. This makes it unlikely that the web W is ripped off. The rotation of the drive motor 70 is also adjusted in conjunction with the change in the transport speed of the web W. This precludes the rubbing of the web which would otherwise occur due to the difference between the speed of the web W and the speed of the rollers.

An instruction is outputted to the remaining web length measuring gauge 44 so that the remaining web length measuring gauge 44 should transmit the current diameter of the web roll (in step S306). Subsequently, it is determined whether or not the current diameter of the web roll has been transmitted by the remaining web length measuring gauge 44 (in step S307). This determination is repeated until the current diameter of the web roll is transmitted.

Once the remaining web length measuring gauge 44 transmits the current diameter of the web roll, the current diameter is received, and is stored in the memory 115 in which the current diameter of the web roll is configured to be stored (in step S308). The reference transport speed of the web W is read from the memory 107 in which the reference web transport speed used during the web threading is configured to be stored (in step S309).

On the basis of the reference transport speed of the web W used during the web threading and the current diameter of the web roll, the rotational speed of the web roll pre-drive motor 26a or 26b which is the motor for rotating the web roll selected for the web threading is calculated. Thereafter, the rotational speed thus calculated is stored in the memory 116 in which the rotational speed of the motor for rotating the web roll selected for the web threading is configured to be stored (in step S310).

Subsequently, the memory value (“1” or “2”) stored in the memory 101 in which the web roll selected for the web threading is configured to be stored is read (Step S311). Thereafter, it is determined whether or not the memory value thus read is equal to “1.” In other words, it is determined whether or not the web roll Wa attached to the A shaft has been selected for the web threading (in step S312).

In a case where a result of the determination is YES, this means that the web roll Wa attached to the A shaft has been selected for the web threading. For this reason, the rotational speed of any one of the web roll pre-drive motors 26a and 26b for rotating the respective web rolls Wa and Wb selected for the web threading is read from the memory 116 in which the rotational speed of the motor for rotating the web roll selected for the web threading is configured to be stored (in step S313). Thereafter, a normal rotation instruction and the read instruction on the rotational speed are outputted to the A web roll pre-drive motor driver 69a (in step S314). Thus, the web roll pre-drive motor 26a attached to the A shaft is rotated at the predetermined speed, and hence the web continues being threaded.

In a case where a result of the determination in step S312 is NO, or in a case where it is determined that the web roll selected for the web threading is that attached to the B shaft, a similar process is applied to the web roll Wb attached to the B shaft. In other words, the rotational speed of any one of the web roll pre-drive motors 26a and 26b for rotating the respective web rolls Wa and Wb selected for the web threading is read from the memory 116 in which the rotational speed of the motor for rotating the web roll used for the web threading is configured to be stored (in step S316). Thereafter, a normal rotation instruction and the read instruction on the rotational speed are outputted to the B web roll pre-drive motor driver 69b (in step S316). Thus, the web roll pre-drive motor 26b attached to the B shaft is rotated at the predetermined speed, and hence the web continues being threaded.

The foregoing embodiments are those in which the present invention is applied to web threading prior to operation of the printing press. However, the application of the present invention is not limited to the web threading. The present invention is capable of being applied to a case where web needs to be transported at a relatively slow speed (for example, a speed not faster than 40 rpm). Furthermore, the application of the present invention is not limited to the printing press. The present invention is capable of being applied to all of the methods each of, and devices each for, threading a strip of paper, cloth and the like in an apparatus.

What is claimed is:

1. A strip threading method of threading a strip into a strip transport route in an apparatus by causing a towing member to hold a forward edge of the strip wound in a roll and by thus moving the towing member while causing the strip wound in the roll to be rotated and unwound by drive means,
the method comprising:
measuring a diameter of the strip wound in the roll before threading the strip into the transport route.

2. A strip threading method of threading a strip into a strip transport route in an apparatus by causing a towing member to hold a forward edge of the strip wound in a roll and by thus moving the towing member while causing the strip wound in the roll to be rotated and unwound by drive means,
the method comprising:
measuring a diameter of the strip wound in the roll while threading the strip into the transport route.

3. The strip threading method as recited in any one of claims 1 and 2, further comprising:
controlling a rotational speed of the drive means for rotating the strip wound in the roll depending on the measured diameter of the strip wound in the roll.

4. The strip threading method as recited in any one of claims 1 and 2, further comprising:
controlling a speed at which the towing member is moved depending on the measured diameter of the strip wound in the roll.

5. A strip threading device for threading a strip into a strip transport route in an apparatus by causing a towing member to hold a forward edge of the strip wound in a roll and by thus moving the towing member while causing the strip wound in the roll to be rotated and unwound by drive means,
the device comprising:
diameter measuring means configured to measure a diameter of the strip wound in the roll before threading the strip into the transport route.

6. A strip threading device for threading a strip into a strip transport route in an apparatus by causing a towing member to hold a forward edge of the strip wound in a roll and by thus moving the towing member while causing the strip wound in the roll to be rotated and unwound by drive means,
the device comprising:
diameter measuring means configured to measure a diameter of the strip wound in the roll while threading the strip into the transport route.

7. The strip threading device as recited in any one of claims 5 and 6, further comprising:
rotation controlling means configured to control a rotational speed of the drive means depending on the measured diameter of the strip wound in the roll.

8. The strip threading device as recited in any one of claims 5 and 6, further comprising:
speed controlling means configured to control a speed at which the towing member is moved depending on the measured diameter of the strip wound in the roll.
